(19) United States
(12) Patent Application Publication
(10) Pub. No.: US 2012/0227077 A1
(43) Pub. Date: Sep. 6, 2012

(54) SYSTEMS AND METHODS OF USER DEFINED STREAMS CONTAINING USER-SPECIFIED FRAMES OF MULTI-MEDIA CONTENT

(75) Inventors: Nova Spivack, Sherman Oaks, CA (US); William D. McDaniel, Bedford, TX (US); John G. Breslin, Porridgetown (IE)

(73) Assignee: Streamglider, Inc.

(21) Appl. No.: 13/410,147

(22) Filed: Mar. 1, 2012

Related U.S. Application Data
(60) Provisional application No. 61/448,177, filed on Mar. 1, 2011.

(51) Int. Cl. H04N 21/643; G06F 3/041; G06F 3/033; G06F 15/16; G06F 3/00

(52) U.S. Cl. 725/110; 709/203; 715/730; 715/863; 345/173

(57) ABSTRACT

Systems and methods are described that allow a user to mix multiple sources of multimedia content from the Web, such as social network accounts, RSS feeds, and other sources of multi-media content. Each of the sources of content, independent of the format and content, is transformed into a homogeneous content container called a frame, and the frames are organized into a cycling chain of content referred to as a stream. The streams are displayed in real-time on a client device as customized multi-media streams. Users can share frames and/or streams with other users.

### CROSS-REFERENCE TO RELATED APPLICATION

This application claims the benefit of and incorporates by reference in its entirety the following: U.S. Provisional Application No. 61/448,177, entitled “SYSTEMS AND METHODS OF USER DEFINED STREAMS CONTAINING USER-SPECIFIED FRAMES OF MULTI-MEDIA CONTENT”, filed Mar. 1, 2011.

### BACKGROUND

The Web offers a large amount of content that a typical user may or may not find interesting or useful. Feed aggregators or news readers assist a user by aggregating in one location syndicated web content for sites that a user selects. Consequently, the user does not have to visit each web site individually to check for the latest updates.

### BRIEF DESCRIPTION OF THE DRAWINGS

Examples of a newsreader system are illustrated in the figures. The examples and figures are illustrative rather than limiting.

FIG. 1A shows a general environment 100A in which a customizable content delivery platform can be implemented.

FIG. 1B depicts a block diagram illustrating an example of components in the host server 110 that support customized mashing and mixing of multi-media content from the Web and presents the content to users in customized streams.

FIG. 1C depicts a block diagram illustrating an example of components in the MNA 199 running on a client device.

FIG. 2 shows an example screenshot of the MNA in a newsreader mode on an iPad in portrait mode. Six vertically stacked streams of customized content are shown on the screen.

FIG. 3 shows an example screenshot of the MNA in the newsreader mode on an iPad in landscape mode.

FIG. 4 shows an example of time-based presentation structures called streams.

FIG. 5 shows an example frame that has been unfolded to a triple-sized frame.

FIG. 6 shows an example of a photo in a stream in slideshow mode.

FIG. 7 shows an example of a slideshow mode for a Tweet.

FIG. 8 shows an example edit mode screen.

FIG. 9 shows an example of delete and reorder functionality buttons.

FIG. 10 shows an example of the addition of a new stream in the user's stream space.

FIG. 11 shows an example list of feed types.

FIG. 12 shows an example edit feed menu.

FIG. 13 shows an example new source menu.

FIG. 14 shows an example of an updated edit feed menu.

FIG. 15 shows an example of a modal view rendered over an edit view.

FIG. 16 shows an example of a modal view.

FIG. 17 shows an example of a screen for the Personalize tab.

FIG. 18 shows an example of a screen for the Browse tab.

FIG. 19 shows an example of a list of feeds.

FIG. 20 shows an example of a list of feeds rendered over an edit view.

FIG. 21 shows an example screen for the Search tab.

FIG. 22 shows an example of a screen for the Google Reader tab.

FIG. 23 shows an example of a modal view of the Google Reader over an edit view.

FIG. 24 shows an example of modal views for different services.

FIG. 25 shows an example panel of services.

FIG. 26 shows an example view for creating a user-based or search-based feed.

FIG. 27 shows an example feed creation screen.

FIG. 28 shows an example screen that presents the user with the option of creating a user-based or search-based feed.

FIG. 29 shows an example screen of a user-based feed form that is presented to the user that can be populated by the user.

FIG. 30 shows an example screen of a search-based feed form that is presented to the user that can be populated by the user.

FIG. 31 shows an example feed creation screen.

FIG. 32 shows an example measurements key that compares a standard size frame card to a double height frame card and a triple height frame card.

FIG. 33 shows an example of the font type and font size used in a standard size frame card and a double height frame card.

FIG. 34 shows an example of the font type and font size used in a standard size frame card for a news image.

FIG. 35 shows an example of the font type and font size for annotated photographs.

FIG. 36 shows an example of a zoomed in screen at double height in landscape mode.

FIG. 37 shows an example of a zoomed in screen at triple height in landscape mode.

FIG. 38 shows an example of a zoomed in screen at double height in portrait mode.

FIG. 39 shows an example of a zoomed in screen at full screen size in portrait mode.

FIG. 40 shows a dog-eared corner on a full-size screen frame.

FIGS. 41A and 41B are a flow diagram illustrating an example process of editing a user's stream space.

FIG. 42 is a flow diagram illustrating an example process of creating a branded newsreader application.

FIG. 43 shows a diagrammatic representation of a machine in the example form of a computer system within which a set of instructions, for causing the machine to perform any one or more of the methodologies discussed herein, may be executed.

### DETAILED DESCRIPTION

Systems and methods are described that allow a user to mix, mash, and track multiple sources of multimedia content from the Web, such as social network accounts, RSS feeds, and other sources of multi-media content. Each of the sources of content, independent of the format and actual content, is transformed into a homogeneous content container called a frame, and frames are organizable by the user into cycling chains of content referred to as streams. The customized streams are displayed in real-time on a client device. Users can share frames and/or streams with other users.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

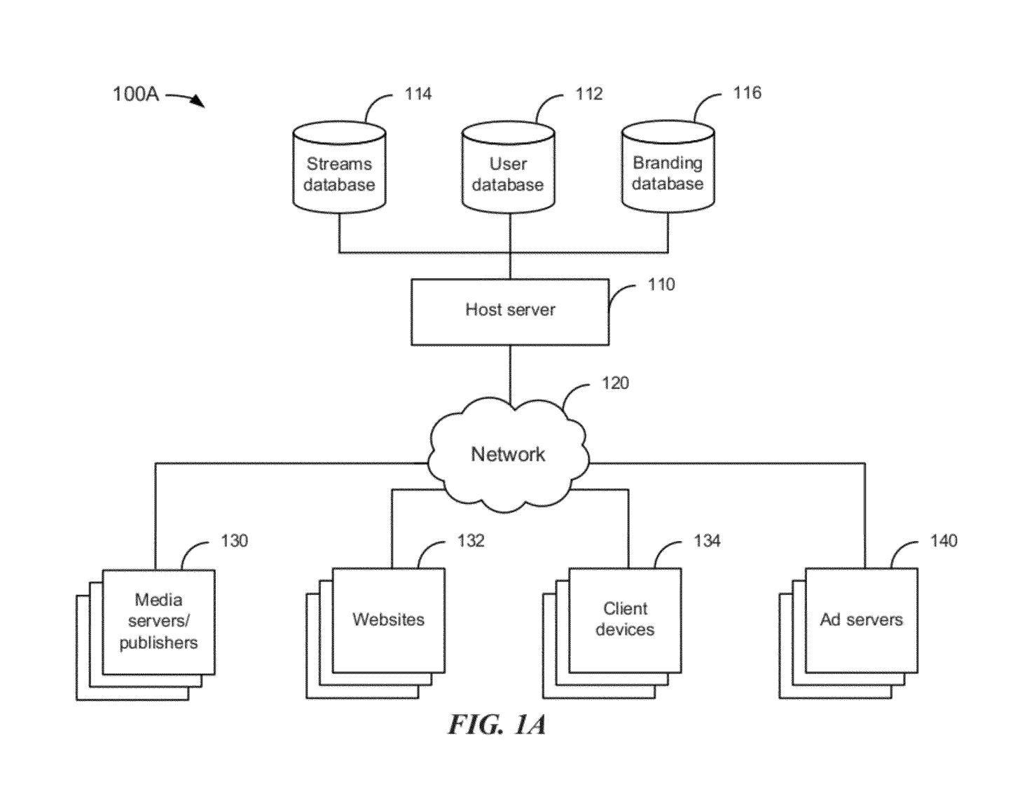

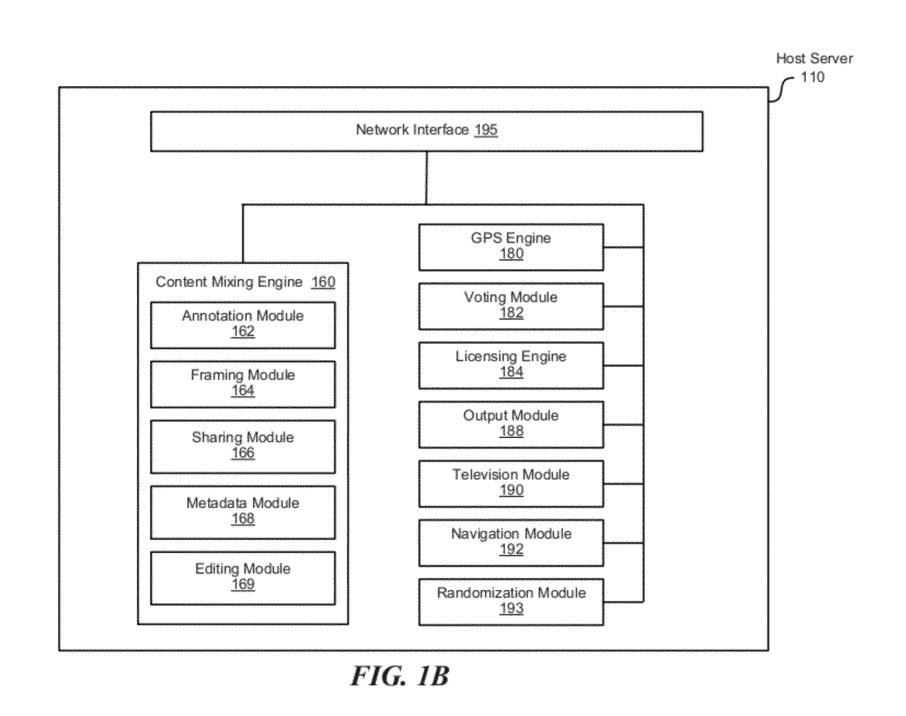

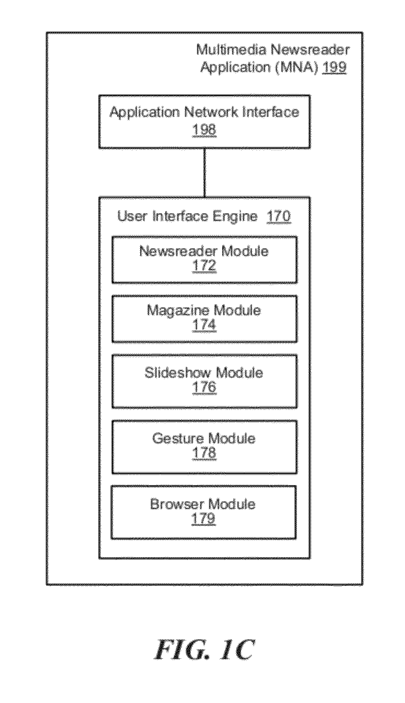

FIG. 1A shows a general environment 100A in which a customizable content delivery platform can be implemented. A plurality of media servers/publishers 130, websites 132, client devices 134, and ad servers 140, and host server 110 are coupled to a network 120. The network 120 can be an open network, such as the internet, or a private network, such as an intranet and/or the extranet. The network 120 can be any collection of distinct networks operating to provide connectivity to the media servers/publishers 130, websites 132, client devices 134, and ad servers 140. Also, more than one host server 110, user database 112, and streams database 114, and branding database 116 may be coupled to the network 120. Only one of each is shown in FIG. 1A for clarity.

The client devices 134 are operated by a user of the client device 134 and can be any system and/or device, and/or any combination of devices/systems that is able to establish a connection, including wired, wireless, cellular connections with another device, a server and/or other systems such as host server 110. Client devices 134 can include a multimedia newsreader application (MNA) 199 to communicate with the host server 110, the user database 112, the streams database 114, and the branding database 116, and with the client device's user interface to present streams to the user. Functions performed by the MNA 199 and the related components therein are described in detail with further reference to the example of FIG. 1C.

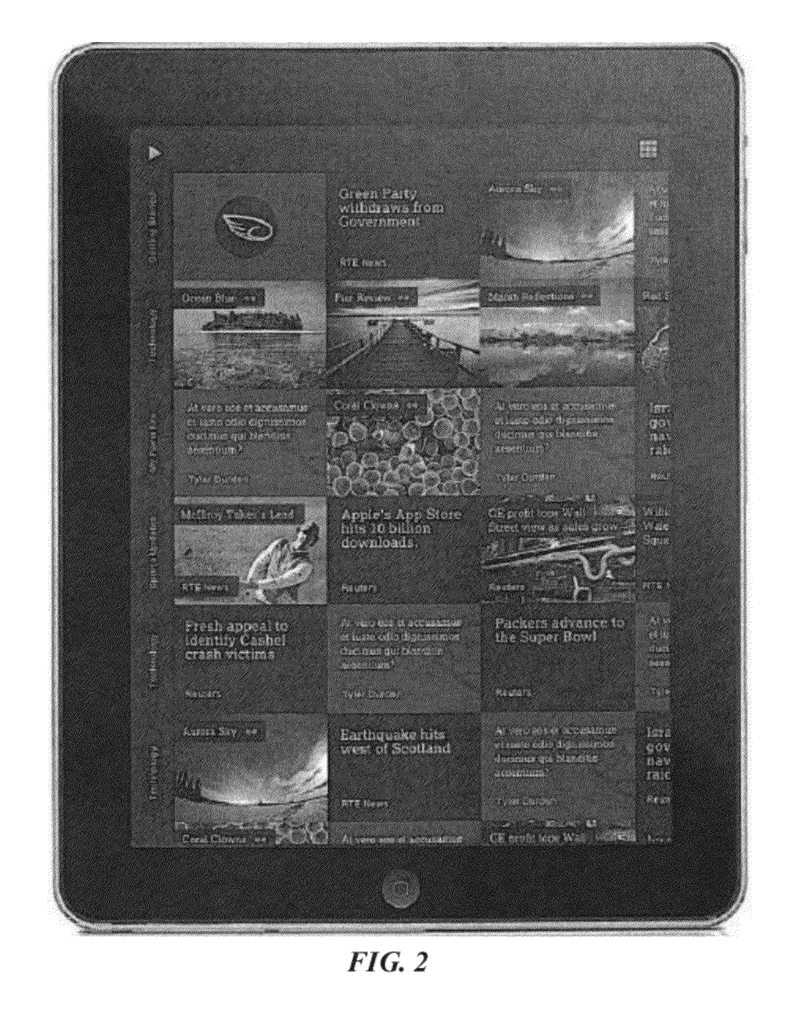

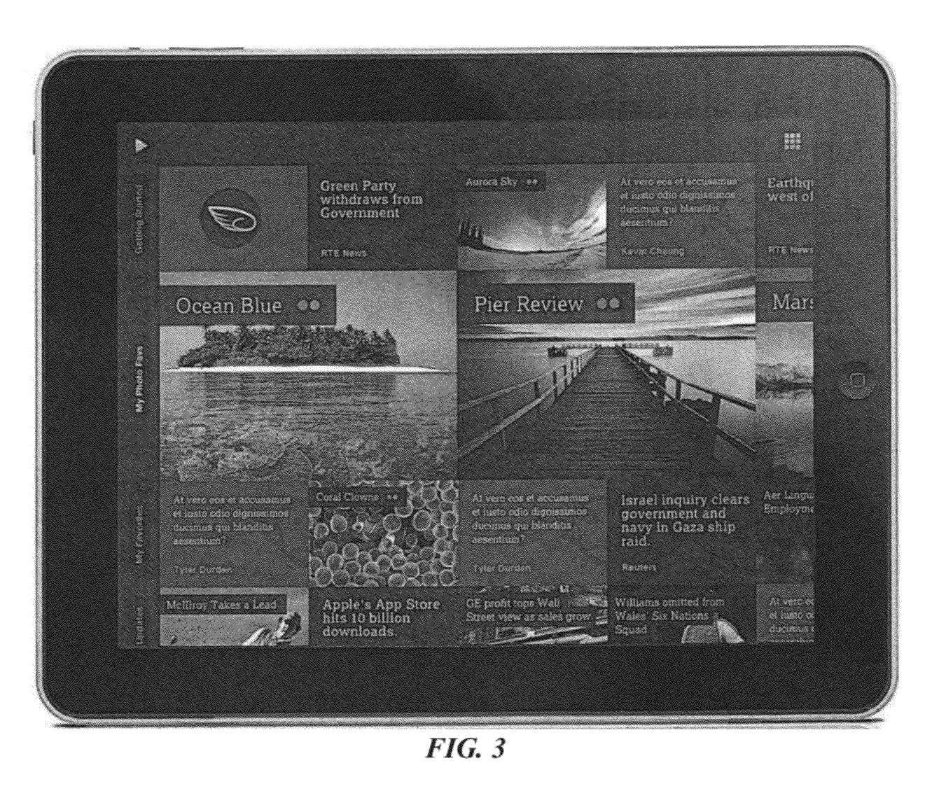

Client devices 134 will typically include a display and/or other output functionalities to present information and data exchanged between or among the client devices 134, the host server 110, the user database 112, the streams database 114, and/or the branding database 116. FIG. 2 shows an example screenshot provided by the MNA 199 in a newsreader mode on an iPad in portrait mode. Six vertically stacked streams of customized content are shown on the screen. FIG. 3 shows an example screenshot provided by the MNA 199 in the newsreader mode on an iPad in landscape mode.

Examples of client devices 134 can include mobile, hand held or portable devices or non-portable devices and can be any of, but not limited to, a server desktop, a desktop computer, a computer cluster, television, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. In one embodiment, the client devices 134 and host server 110 are coupled via a network 120. In some embodiments, the devices 134 and host server 110 may be directly connected to one another.

The input mechanism on client devices 134 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

Signals received or detected indicating user activity at client devices 134 through one or more of the above input mechanism, or others, can be used in the disclosed technology by various users for accessing, through network 120, a customizable content delivery platform (e.g., hosted by the host server 110).

Users of the client devices 134 access the host server 110 to view or browse customized streams of content from the Web of interest to the user and to share content with other users. Media servers/publishers 130, for example, YouTube, ESPN, and MSN, provide information, online events, and other types of data over the Web. Media servers/publishers 130 can send information and data to the host server 110 for presentation to client devices 134, and interested users can select particular media servers/publishers 130 of interest for inclusion in a stream for viewing.

Websites 132 include blogs and other sites that provide information. Advertisement servers 140 are entities that serve advertisements for presentation to client devices 134 in or near streams presented to user.

The user database 112, streams database 114, and branding database 116 can store information such as data, images, video. The database 112, streams database 114, and branding database 116 can be managed by a database management system, for example, Oracle, DB2, or Microsoft Access.

The user database 112 stores data about a user such as name, email address, sources of content of interest of the user, subjects of interest to the user, and statistical information about the user's content viewing habits.

The streams database 114 stores titles and sources of content for each stream associated with a user. The streams database 114 can also include voting or ratings information from a user about frames within a stream and an emotional reaction of the user to frames. The streams database 114 can also include shared streams and the users permitted access the shared streams as well as public streams accessible to all users. Further, the streams database 114 can include, annotations of frames and/or streams, framing structures for frames, and metadata for the frames and/or stream.

The branding database 116 stores elements of identity, such as logo and name and color scheme, provided by a licensee desiring to distribute a branded newsreader application. The branding database 116 can also include streams with pre-selected content for distribution by licensees, a directory of feeds available to users, and featured content sites.

The host server 110 can communicate with media servers/publishers 130, blogs 132, and client devices 134, and ad servers 140 via the network 110. Further, the host server 110 can retrieve data from and add data to the user database 112, streams database 114 and branding database 116.

FIG. 1B depicts a block diagram illustrating an example of components in the host server 110 that support customized mashing and mixing of multi-media content from the Web and presentation of the content to users in customized streams.

The host server 110 can include, for example, a network interface 195, a content mixing engine 160, a GPS engine 180, a voting module 182, a licensing engine 184, an output module 188, a television module 190, a navigation module 192, and/or a randomization module 193. Additional or fewer components/modules/engines can be included in the host server 110 and each illustrated component.

The network interface 195 can be a networking module that enables the host server 110 to mediate data in a network with an entity that is external to the host server 110, through any known and/or convenient communications protocol supported by the host and the external entity. The network interface 195 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

As used herein, a “module,” or an “engine” includes a general purpose, dedicated or shared processor and, typically, firmware or software modules that are executed by the processor. Depending upon implementation-specific or other considerations, the module or engine can be centralized or its functionality distributed. The module or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

In one embodiment, the host server 110 includes the content mixing engine 160 that accesses sources and feeds on the Web to obtain multi-media information and prepares the multi-media information to be displayed in user customized mixed-media formats. The content mixing engine 160 takes heterogeneous information packets, for example, RSS feeds, video, audio, social network API's, and XML, from multiple sources and organizes the information packets into homogeneous content containers called frames that are subsequently organized into time-based presentation structures called streams, as shown, for example, in FIG. 2. Thus, the content mixing engine 160 can accept as input several different feed styles, formats, content, and media and transform the input into a presentation format that includes consistent, packaged content containers which we call frames and then organizing those frames into independently cycling chains of content which we call streams.

Users can interact with the content mixing engine 160 to create personalized streams of content by mashing up or mixing content that may be provided by a feed or source in a variety of different forms, for example, RSS (really simple syndication) feeds, video, and social network application programming interfaces (APIs), to provide user-generated information channels. The personalized streams are stored in the streams database 114.

A set of user-defined streams containing frames of multi-media content received from user-specified sources forms the user's personal stream space. Stream spaces allow users to define and view their own private preferential view of multi-media content. Further, as described below, a user can annotate and share elements of his streams with others.

The content mixing engine 160 provides the streams of frames to a user interface engine 170 in the MNA 199 for presentation on the client device to the user. For example, in newsreader mode, the streams of frames are presented in a cyclic, time-based manner on the screen of the user's client device, essentially as a ticker of frames. The frames scroll across the user's client device and cycle back around when the last defined frame in a stream has been displayed. The content mixing engine 160 periodically checks the frame sources for new content and updates the frames when new content is available. Updated frames can be added to the ticker forming a temporally ordered series of frames of content. Frames within a stream may cycle through the ticker indefinitely or until they expire according to various rules. Non-limiting examples of expiration rules applied by the content mixing engine 160 include expiring after a certain number of rotations, expiring after a certain amount of time, expiring after they have been clicked on or read, expiring after an expiration date for the content, or expiring after some other expiration-triggering event.

In one embodiment, the content mixing engine 160 can include an annotation module 162, a framing module 164, a sharing module 166, a metadata module 168, and/or an editing module 169.

The annotation module 162 receives annotations provided by a user a frame and/or a stream and stores them in the streams database 114. The annotations are accessed by the MNA 199 for presentation on the client device 134 to the user.

The framing module 164 establishes the framing structure for a frame in a stream and stores the framing structures in the streams database 114. The framing structure includes the link to the multi-media content contained by a frame as well as properties of the frame. Non-limiting examples of frame properties include color scheme, labels, comments, and annotations.

The sharing module 166 can receive a designation of one or more frames or streams to be shared with other specified users who use the customizable content delivery platform hosted by the host server 110. The sharing module 166 stores this information in the streams database 114. When a user requests access to a stream that is not owned by the user, the sharing module 166 checks whether the user has been designated as a user permitted to access the stream.

When a user identifies a frame to be shared, the shared frame includes not only the link to the multi-media content contained by the frame, but also the framing structure for the frame or frame properties. Once a user has shared a frame, the recipient of the frame can integrate the frame into his own stream space as displayed on the recipient's client device. Additionally, the contents of frames can be shared with others who do not use the customizable content delivery platform.

In one embodiment, the sharing module 166 can receive a designation of an entire stream of frames to be shared with select users, rather than just a single frame of the stream. Once a user has shared a stream, the recipient of the stream can integrate the stream into his own stream space.

In one embodiment, the sharing module 166 allows a user to designate selected frames to add to a common public stream available to be viewed by all users of the customizable content delivery platform hosted by host server 110. A user can also limit access to a designated stream to specific users identified by the first user. The sharing module 166 can track permissions assigned to a stream by storing the permissions in the streams database 114. Thus, if a user has permission to modify a designated shared stream, upon request by the user, the sharing module 166 loads the designated shared stream to the user's client device. Then the user can add frames from the user's stream space to the designated shared stream. The newly added frames are also stored by the sharing module 166 in the streams database 114 and any user who has permission to access the stream will see these new frames appear the next time the shared stream cycles through on the user's client device. In one embodiment, the user can add frames by dragging and dropping frames from one stream to another.

The metadata module 168 can attach metadata to the streams and/or frames created by a user. Some of the metadata is already available in the information provided by the source of the content for the frames. The metadata module 168 can also receive metadata from users to attach to streams and/or frames. In one embodiment, the metadata module 168 can analyze the streams and/or frames to generate new metadata. Non-limiting examples of attachable metadata include data describing how to render the content, read-write permissions for access to the content, provenance for the content, links to related content, library reference information related to the content, product SKU (stock-keeping unit) or ordering information, e-commerce affiliate codes, relevant concepts, taxonomy or ontology links, semantic metadata, header information, sentiment data, content usage statistics, application-specific metadata, user-account metadata, or other fields of additional data including customizable data. The metadata is stored in the streams database 114.

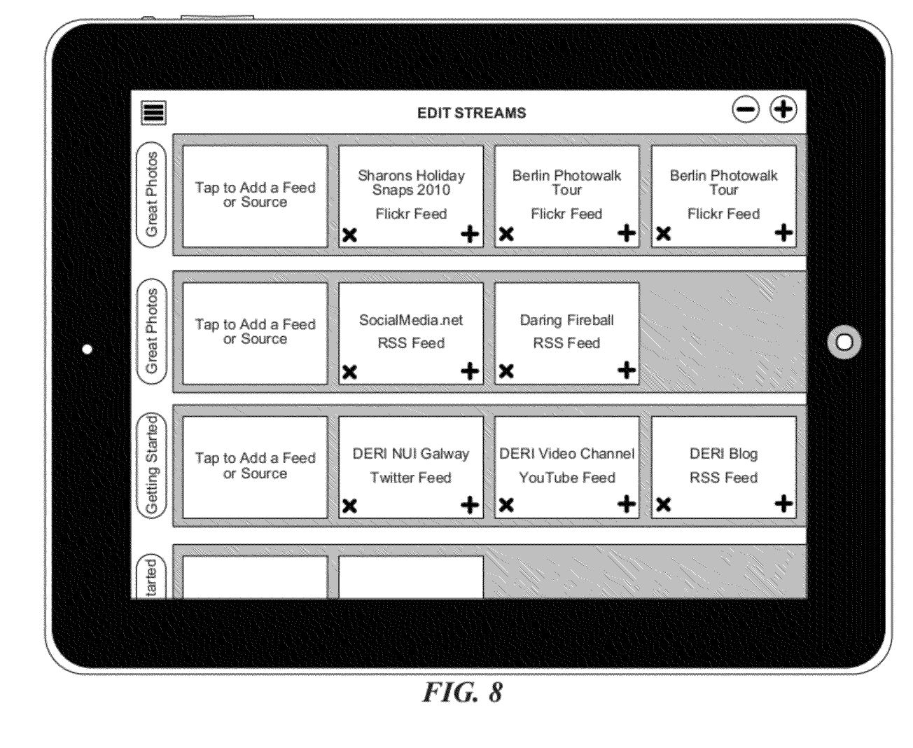

When a user wishes to add a new stream, add a new feed or source to a stream for a new frame, or edit a frame or a stream, the user selects the edit mode in the MNA 199. In response, the editing module 169 generates an interactive edit mode screen for display on the user's client device. The editing module 169 receives commands from the user in the edit mode through the user's selection of appropriate icons on the edit mode screen, as described below, or the user's selection of appropriate buttons or menus. FIG. 8 shows an example screen provided by the MNA 199 in edit mode. Each of the streams shown in a horizontal row is encased for easy identification of a stream. Each frame is represented by a card, and the lower left corner of each card has a delete button that causes the frame to be deleted from the stream when selected. The lower right corner of each card has a move button that upon clicking allows a user to drag the card to move its order within the same stream or to move the card to a location in a different stream. The upper left corner of the edit mode screen has a reordering icon. Selecting this icon allows a stream to be selected and dragged to a different order in the presentation of streams on the screen.

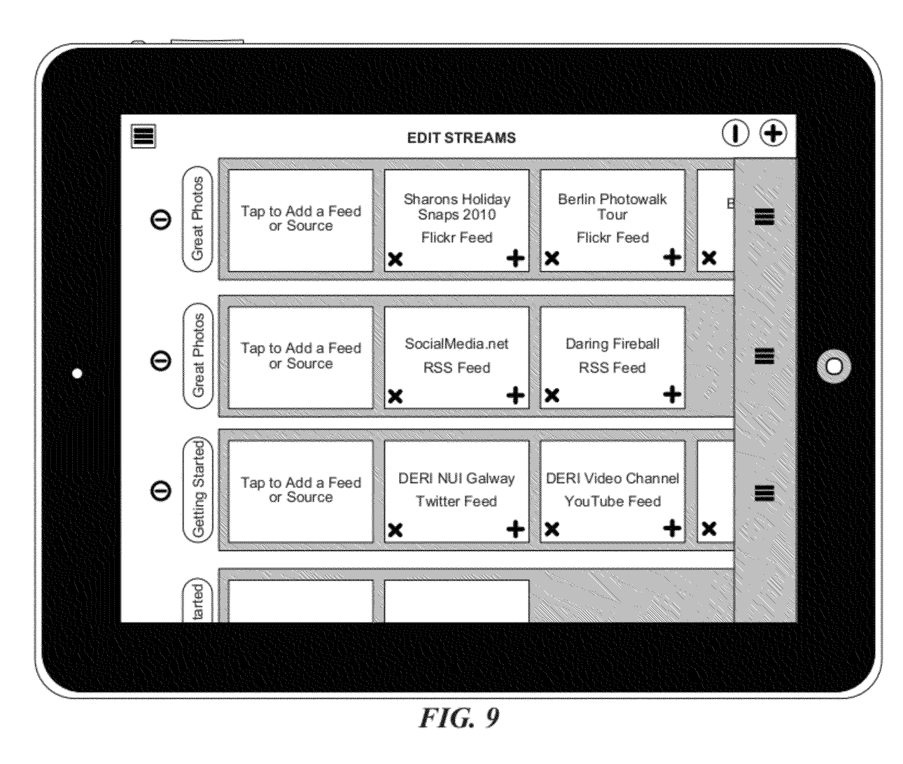

The upper right corner of the edit mode screen has a delete (minus sign) button and an add (plus sign) button. Selecting the delete button results in the appearance of delete and reorder functionality buttons, as shown in the example of FIG. 9. To the left of each stream's title, a delete icon (minus sign) appears. If a user selects one of these delete icons, the entire corresponding stream is deleted. On the right side of the screen are reordering icons for each stream. If a user selects the reordering icon for a stream, the stream can be moved to a different position in the presentation of streams on the screen. Further, the delete icon in the upper right corner of the screen changes to a vertical position to indicate the current functionality selected by the user. Once the delete icon is tapped by the user, it returns to its horizontal state in the original edit mode where the delete and reordering icons are hidden.

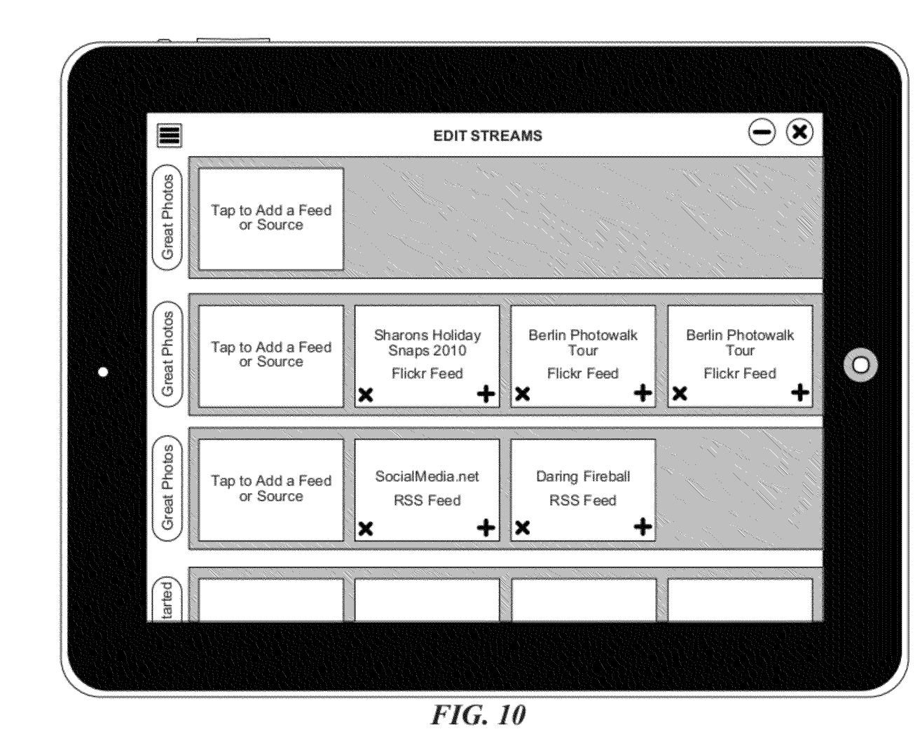

Selecting the add button in the upper right corner results in the inclusion of a new stream in the user's stream space as shown in the example of FIG. 10 near the top of the screen. Additionally, the add icon in the upper right corner of the screen rotates to represent a close button. If the user taps on the rotated add button, the new stream is deleted. Otherwise, if the user adds a source to the new stream to create a new frame in the new stream, the add button rotates back to its original position by default so that the user can add additional streams.

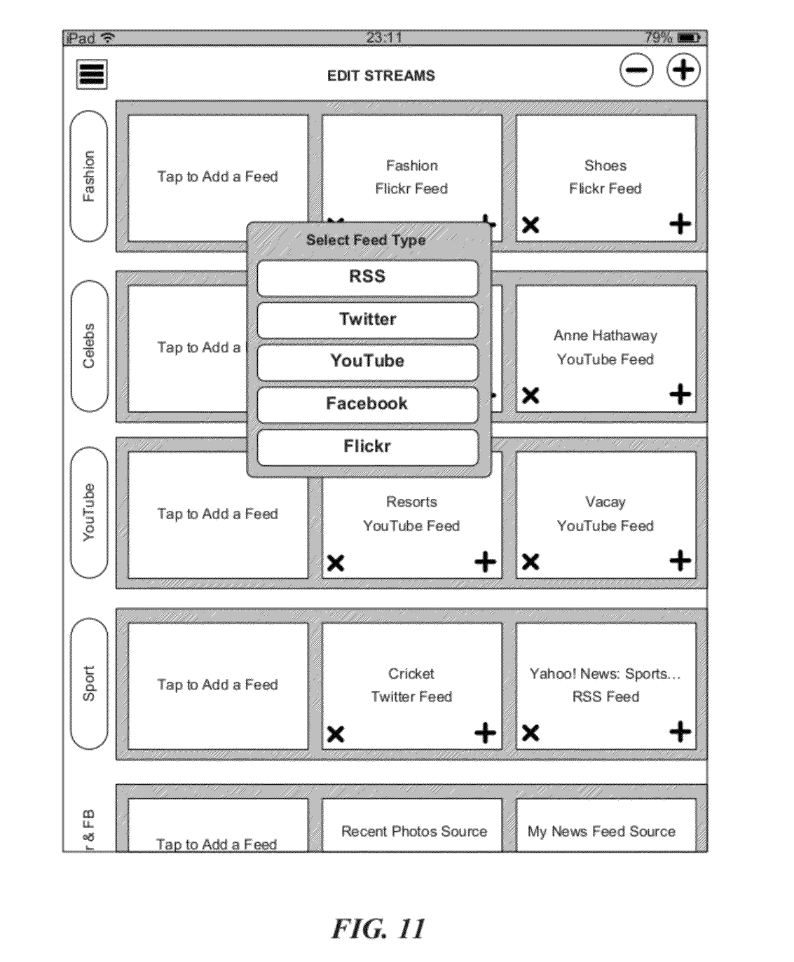

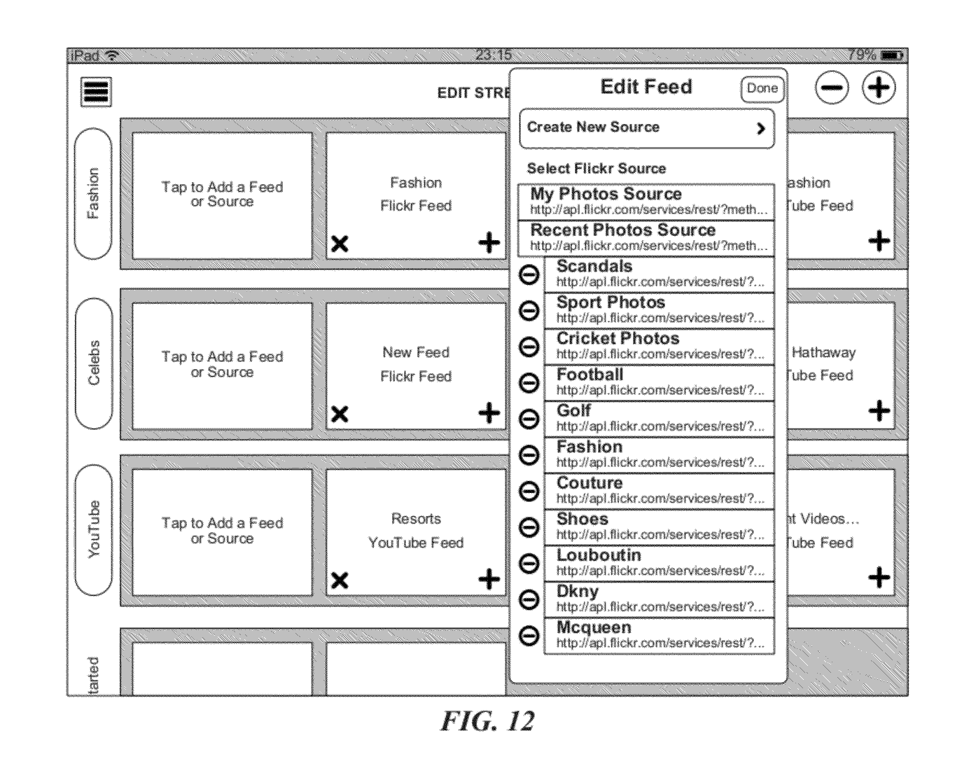

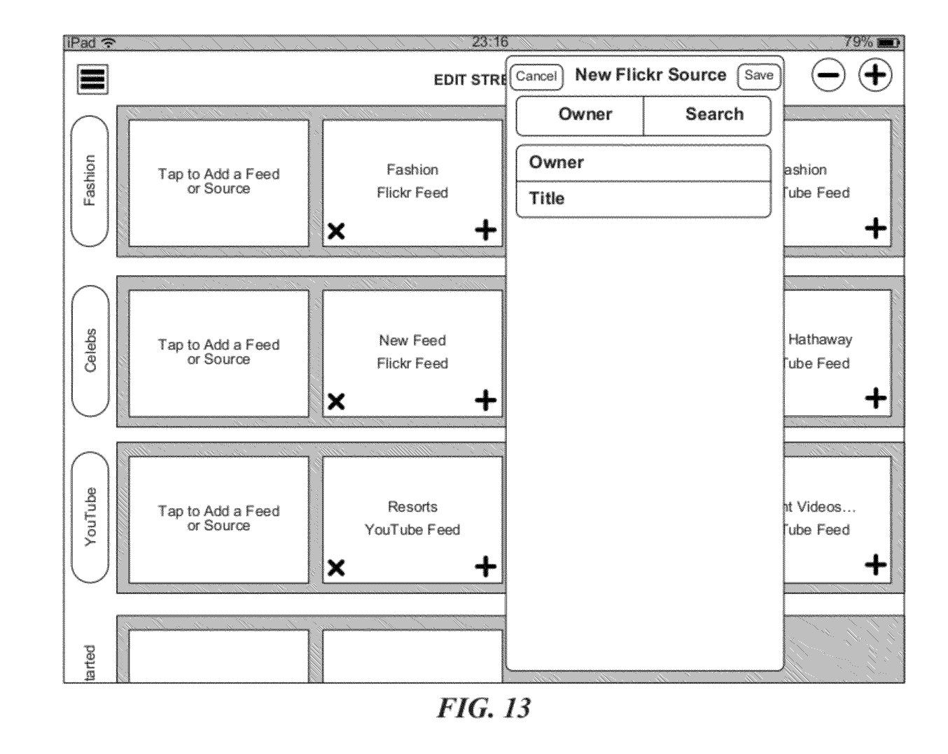

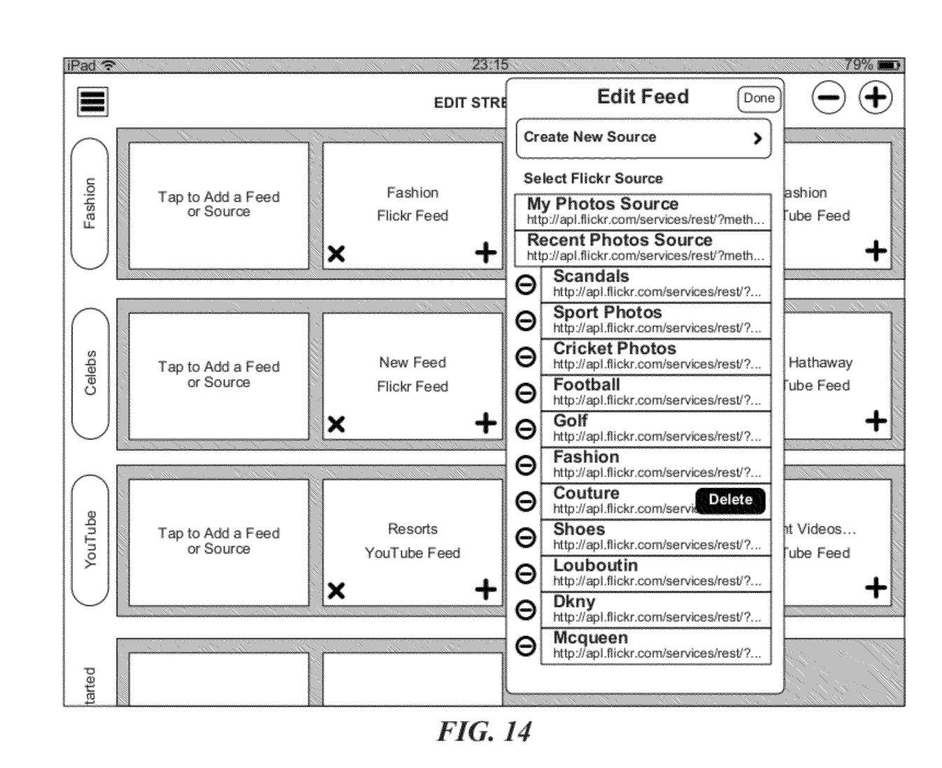

In one embodiment, in the edit mode presented by the editing module 169, the user can tap the first card or add card in each stream to add a feed or a source to that stream. Upon tapping the first card, in one embodiment, a list of feed types is presented to the user over the background of the streams shown in edit mode, as shown in the example of FIG. 11. Example feed types include RSS, Twitter, YouTube, Facebook, and Flickr. Upon clicking on the Flickr feed type, for example, the example edit feed menu shown in FIG. 12 is presented to the user. The feed menu includes categories of sources of Flickr photos that can be selected by the user. If the user chooses the selection from the edit feed menu to create a new source, the example new source menu shown in FIG. 13 is presented to the user. The user can either find a feed by entering the owner and title, or perform a search. From the example edit feed menu shown in FIG. 12, the user can select the delete (minus sign) button next to one of the listed Flickr source categories. The user is then presented with the updated example edit feed menu shown in FIG. 14 where a delete button appears.

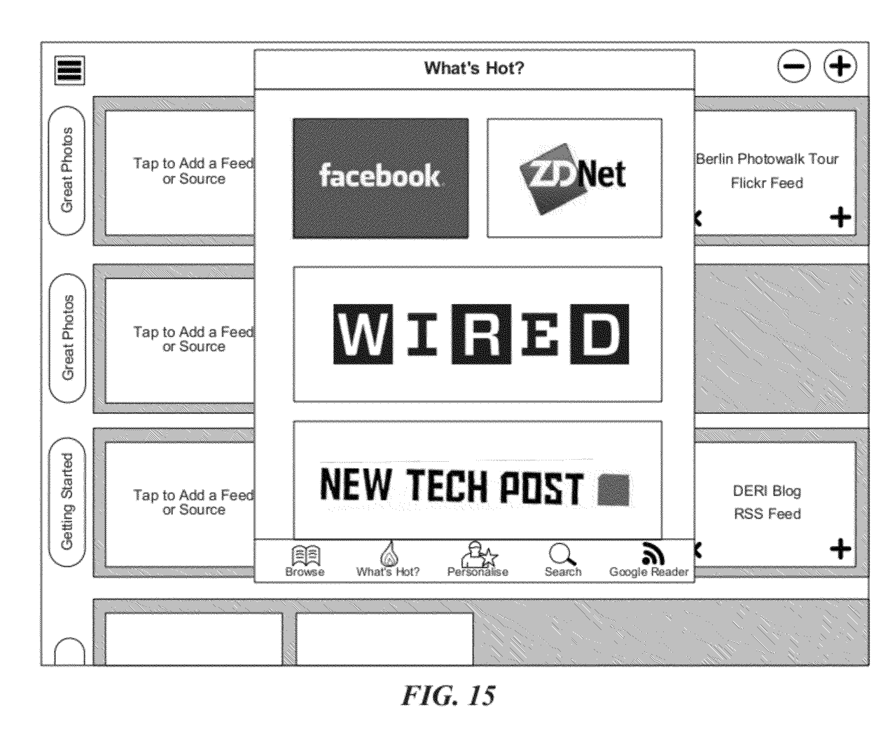

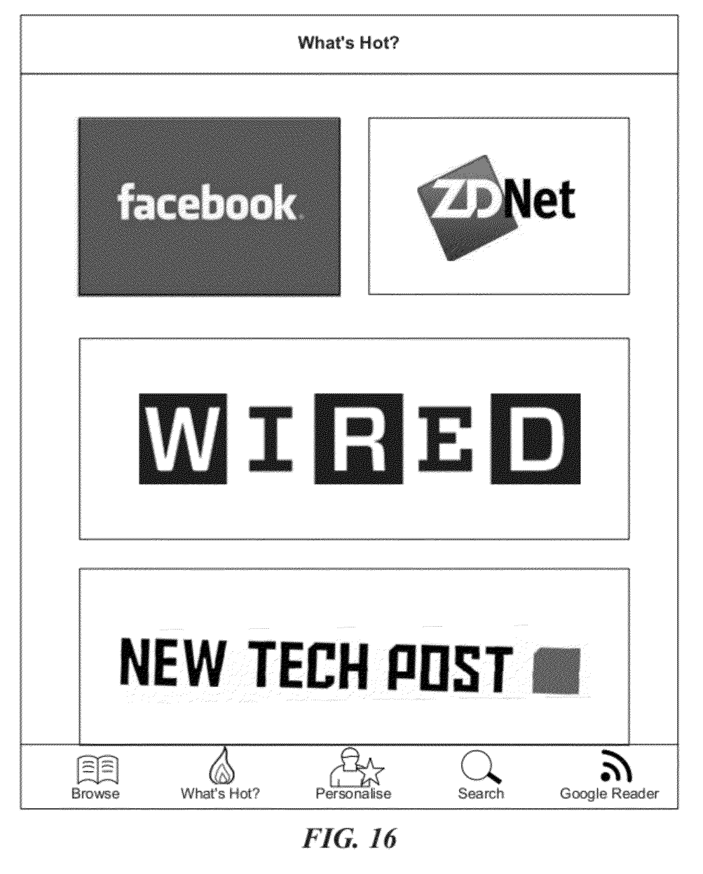

In one embodiment, in the edit mode presented by the editing module 169, upon tapping an add card in a stream, the user is presented with a modal view that is rendered over the edit view as shown in the example of FIG. 15. For clarity, an example of the modal view is shown alone in FIG. 16. On the bottom of the modal view is a bar that can include tabs provided by the editing module 169 for different ways of pushing content to the user. In the example of FIG. 16, there are five tabs, Browse, ‘What's Hot?’, Personalize, Search, and Google Reader. The ‘What's Hot?’ tab is a visual directory of feeds that alerts users to new and popular feeds that a user can select for adding to a stream. In one embodiment, the ‘What's Hot?’ screen includes dynamic content panels in which a series of graphic cards promoting the new feeds can be added. Upon tapping on any of the panels by a user, the editing module 169 presents the feed entry to the user, and the user simply taps to add the feed entry.

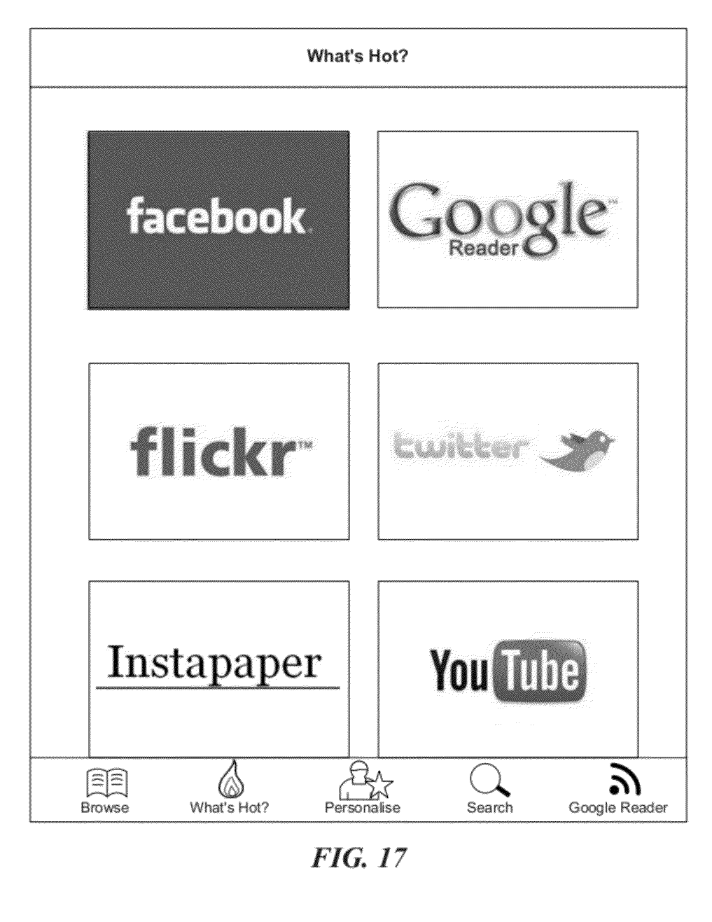

The screen for the Personalize tab, as shown in the example of FIG. 17, includes a listing of the services that a user can tap into, for example Facebook, Google Reader, Flickr, Twitter, Instapaper, and YouTube. More services can be added to this screen as they become available. Each of the services is assigned a card in the Personalize screen view, and the card links to the corresponding service screen where a user can input details and create custom feeds based on personal preferences. In one embodiment, the Personalize tab is a web view by which content can easily be added and removed.

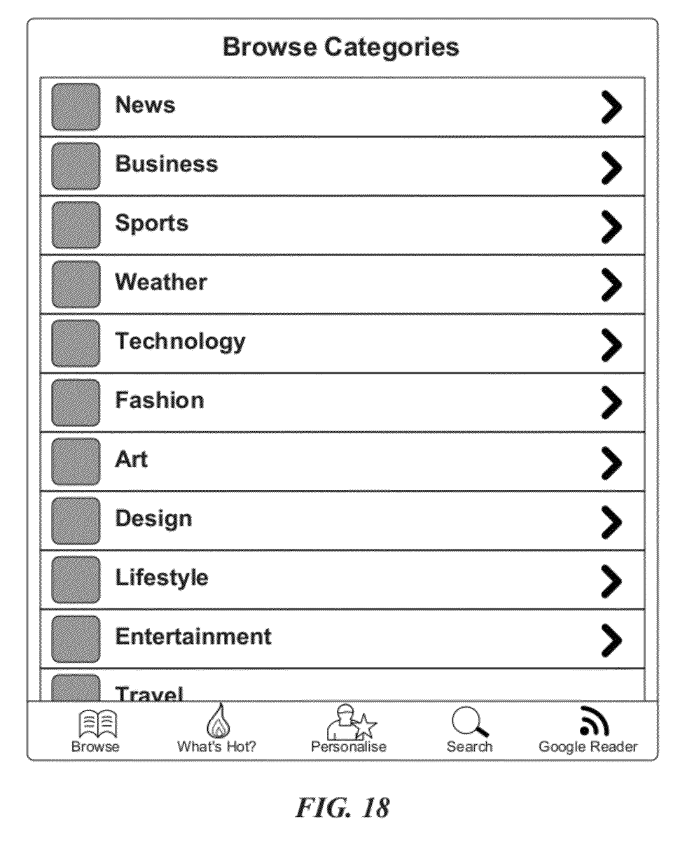

The screen for the Browse tab includes a directory of RSS feeds broken down by category, as shown by the example list in FIG. 18. Example categories of feeds include, but are not limited to, news, business, sports, weather, technology, fashion, art, design, lifestyle, entertainment, and travel. In one embodiment, the feeds can be stored in an OPML (Outline Processor Markup Language) file that is editable and maintained through a web interface. The file can contain a hierarchical list of feeds by which a user can drill down to find and add feeds of interest. In the example of FIG. 18, there is a blank square next to each top-level category that can be replaced by a pictogram or a quad representative of the content of that category.

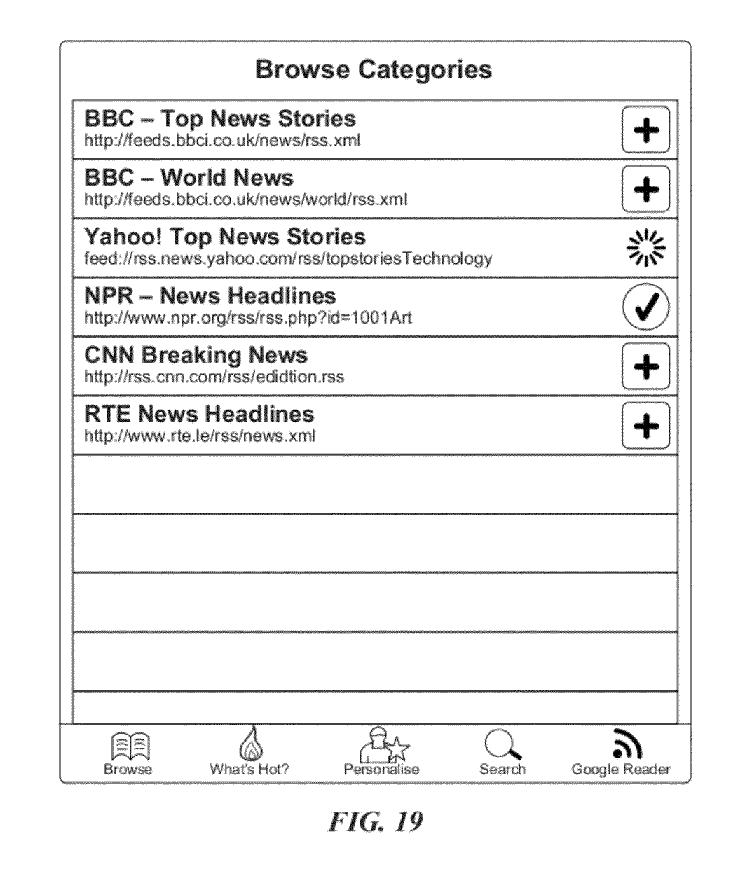

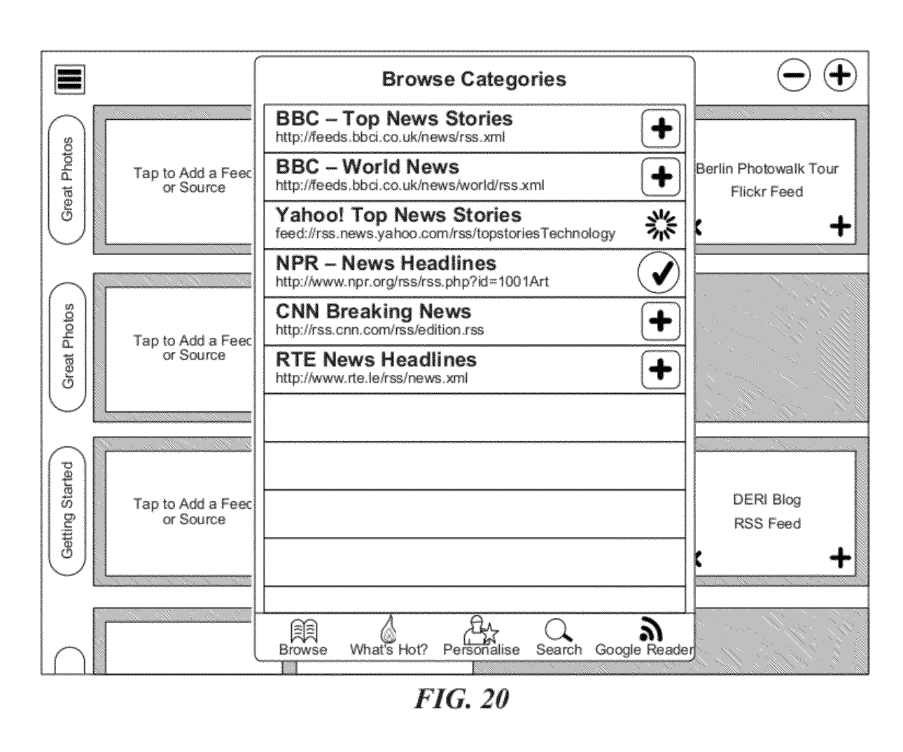

As shown in the example of FIG. 19, when a list of feeds is presented, it features the main title of the feed and presents the URL (uniform resource locator) for each of the feeds. To the right of each feed is a button that a user can tap on to add the corresponding feed. A spinner indicator can be used to indicate the process of adding the feed is not yet complete, and when the feed has been successfully added to the user's stream, a correction tick can be used to indicate a successful completion status. Because the user can make multiple requests, it is important to provide feedback to the user on the status of the process of adding each feed. FIG. 20 shows the feed list of FIG. 19 on the edit mode background.

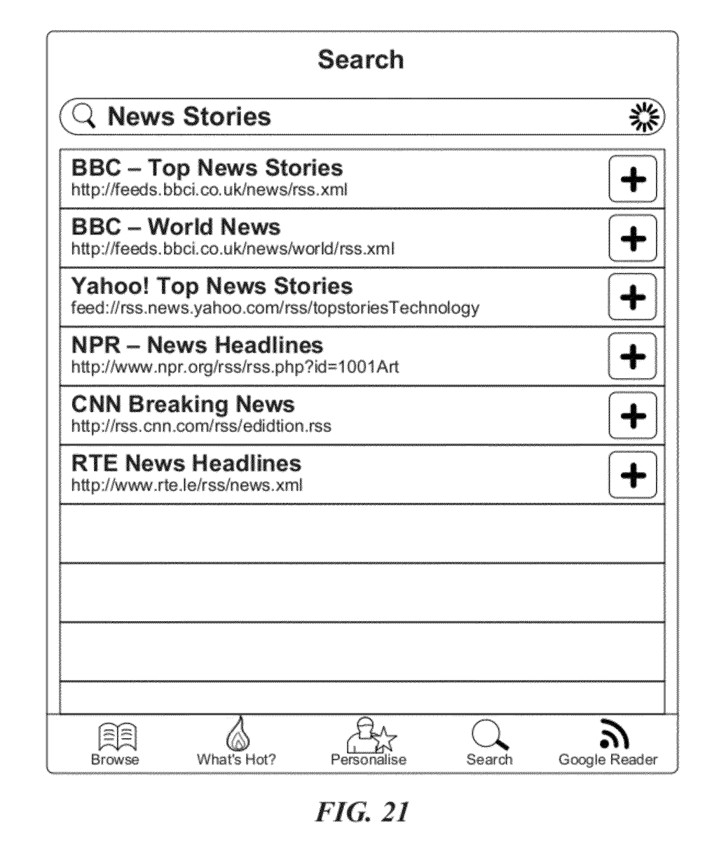

The screen for the Search tab includes functionality that allows a user to search through a bank of RSS feeds and provides the user with a results/SERP (search engine results page) mini-screen from which the user can tap selections to add to the user's stream. In one embodiment, the results are presented in a liveview where results are returned automatically as a user types in a search term. FIG. 21 shows an example screen for the Search tab. A loading indicator is used in the search bar to indicate to the user that the editing module 169 is actively searching.

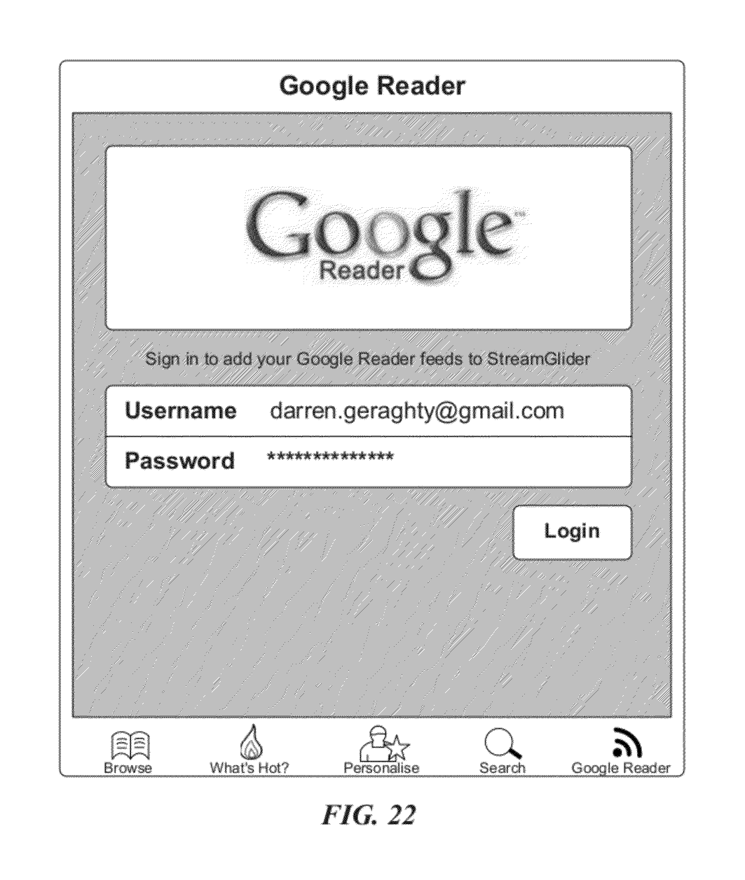

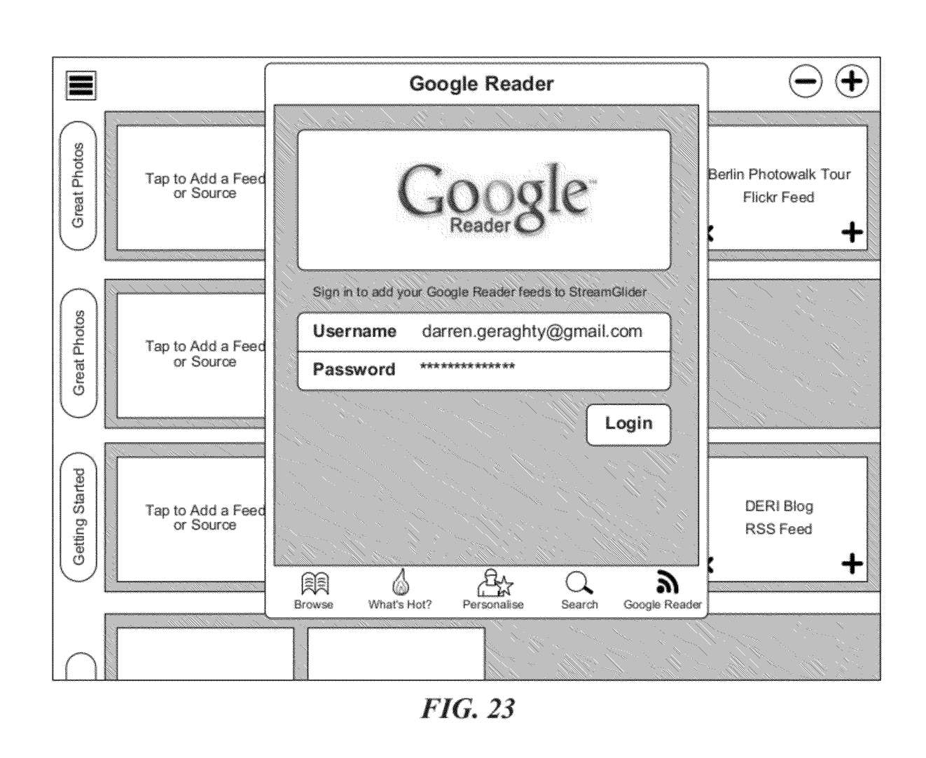

The screen for the Google Reader tab, as shown in the example of FIG. 22, presents a branded screen that presents input boxes and a login button. Once a user logs into his account for Google Reader, the user will be presented with a table of entries, similar to the search results shown above, where the user can just tap on a feed to add it to a stream. Some services may require the presentation of the service's own login pages which can be presented within the modal window contained in a web view to make the process seem fluid to the user. FIG. 23 shows the modal view of the Google Reader tab of FIG. 22 on the edit mode background.

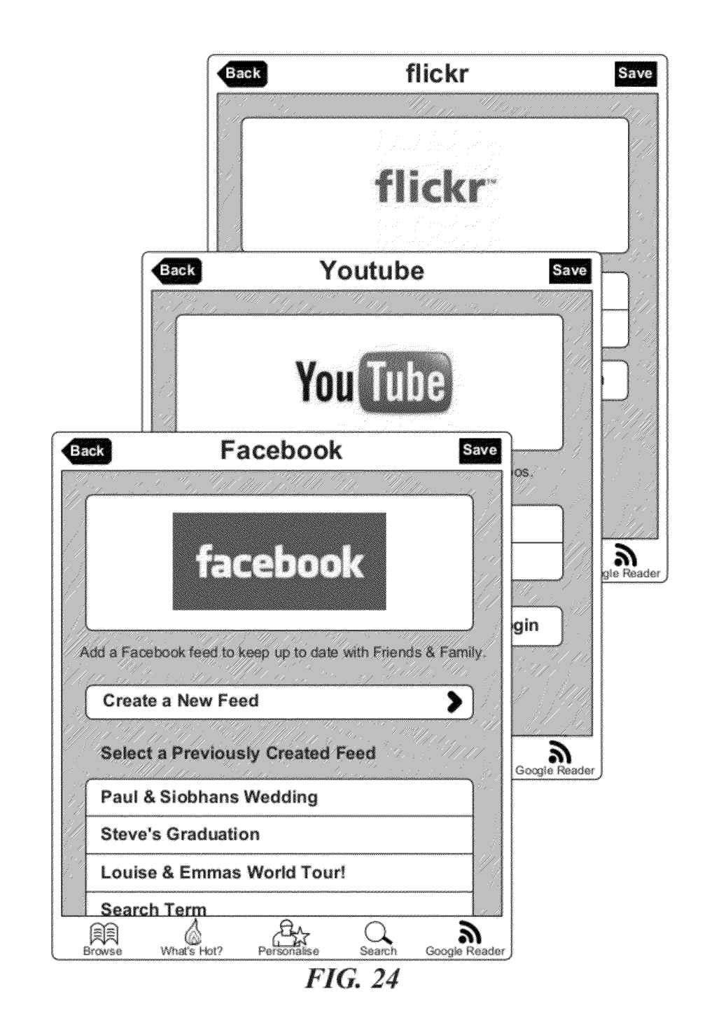

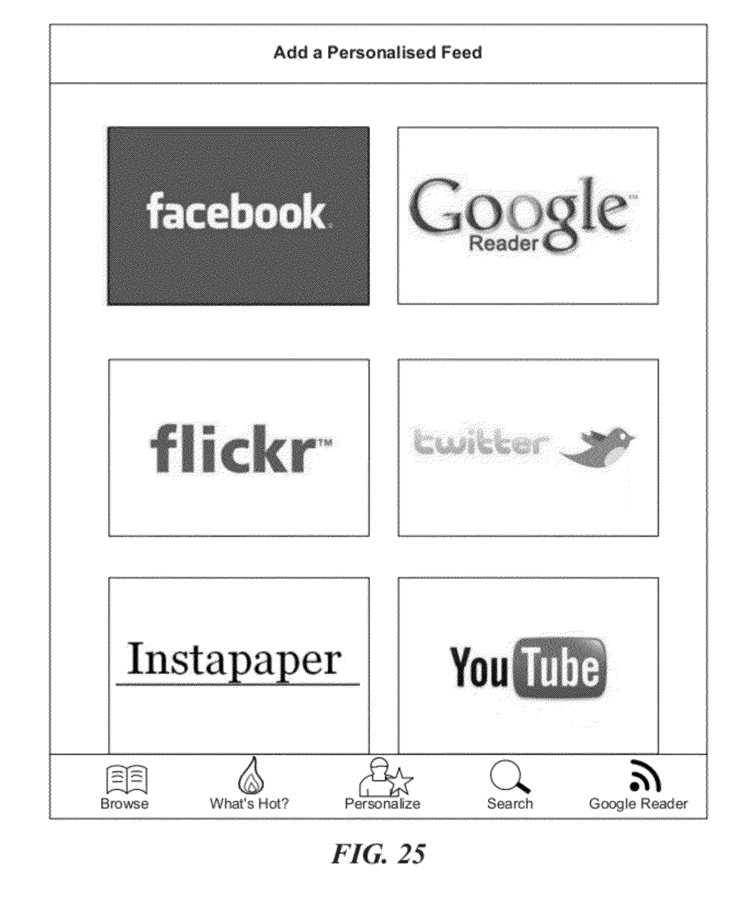

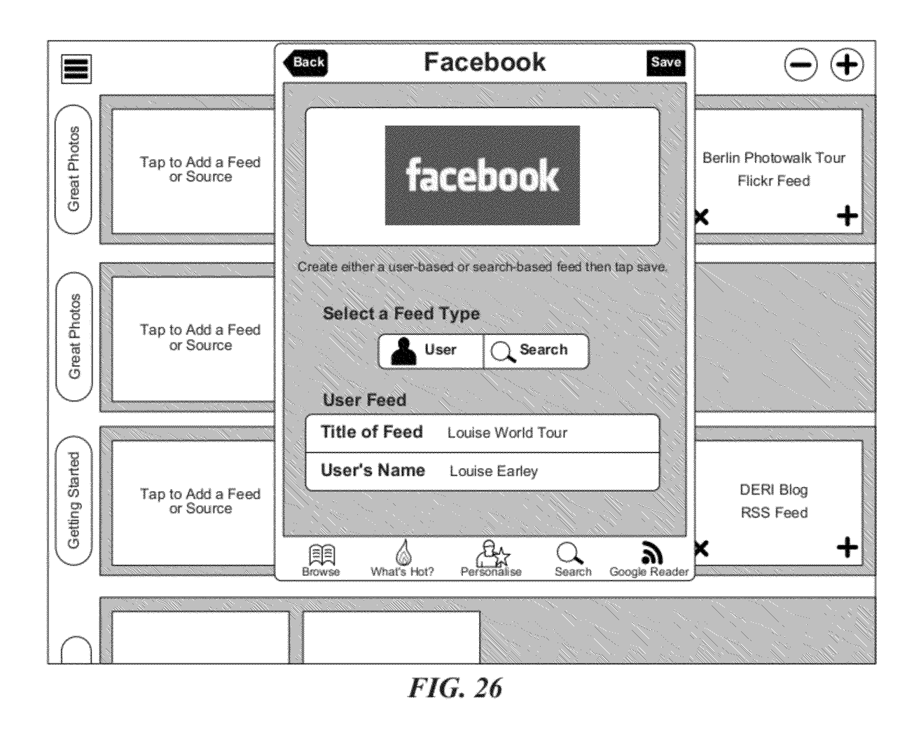

A user can also create his own personalized feeds, for example, with Facebook, YouTube, or Flickr. At least partial modal views for these services are shown in FIG. 24. In one embodiment, if a user wants to create a Facebook feed for one of the user's streams, the user taps on the Personalize icon on the bottom bar which brings up the modal view shown in the example of FIG. 25. Then a tap on the Facebook panel brings up the Facebook modal view shown in the example of FIG. 26 where the user can either create a user-based or search-based feed.

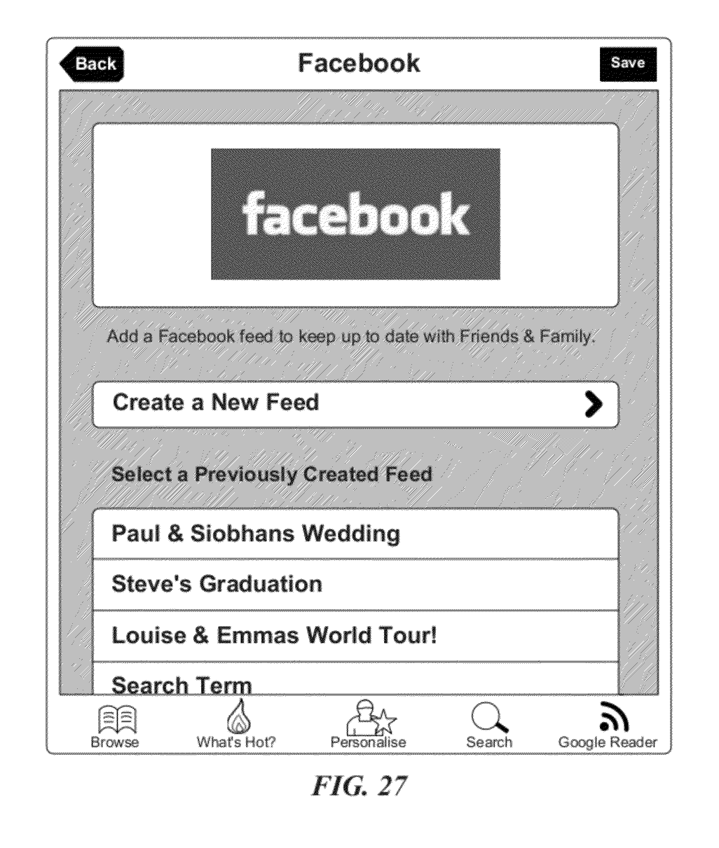

FIG. 27 shows an example screen that presents a brief explanation of what a personalized feed allows the user to do. The user can select a previously created feed by tapping on one of the listed previously created feeds to add the feed to the user's stream. Alternatively, the user can create a new feed by clicking on that option.

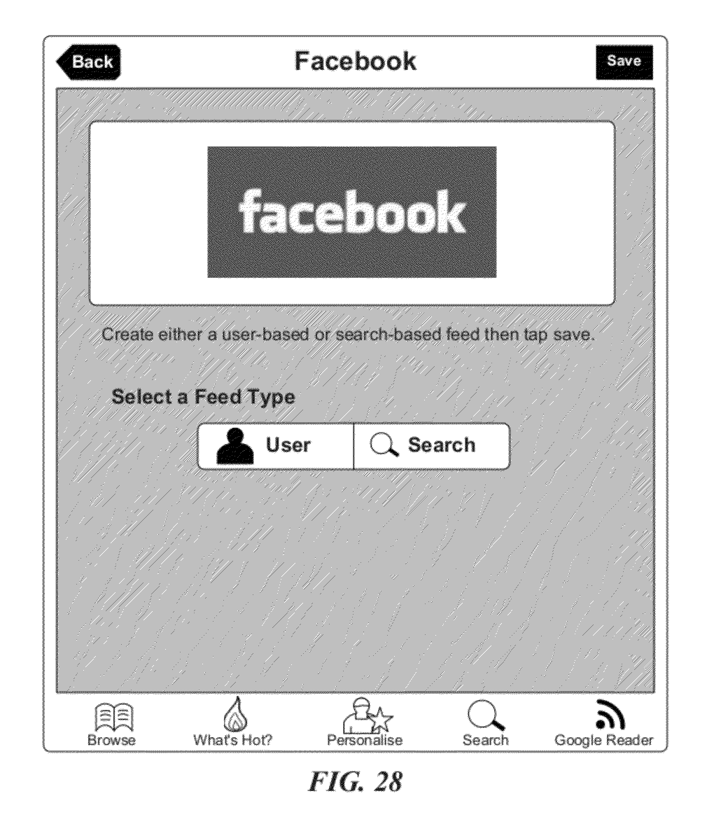

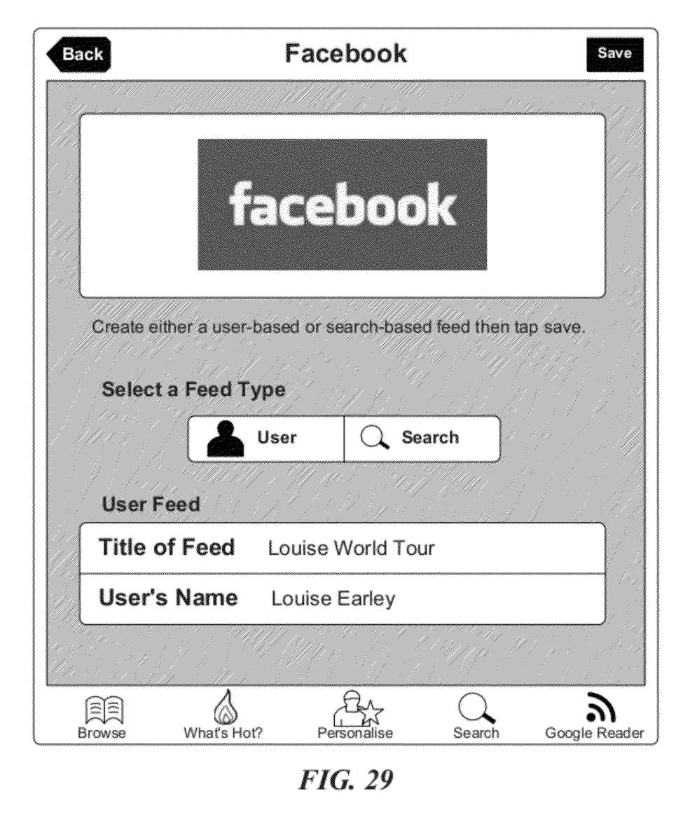

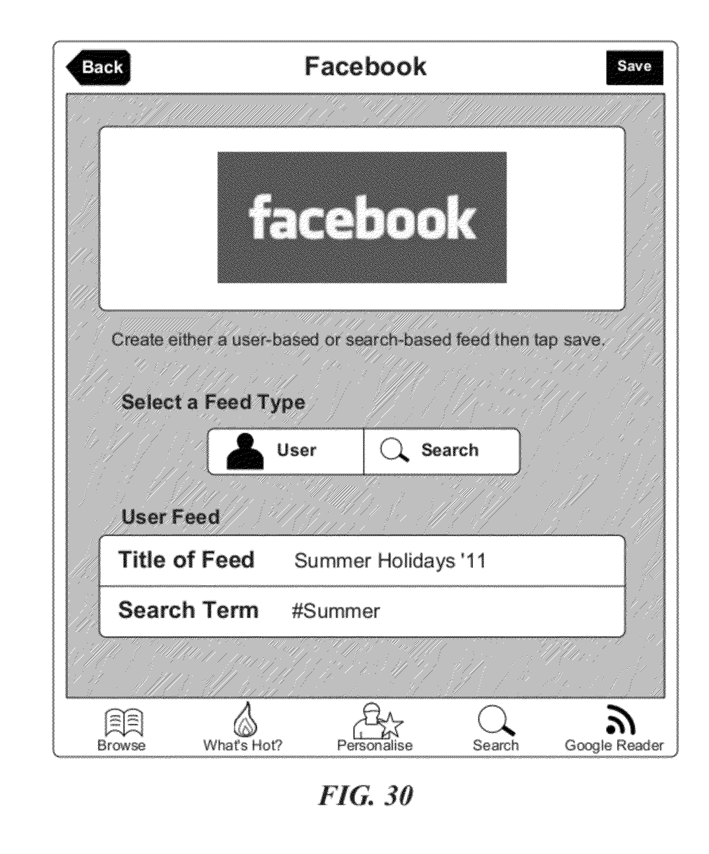

FIG. 28 shows an example screen that presents the user with the option of creating a user-based or search-based feed. If the user wishes to create a user-based feed, the user taps on the ‘User’ tab. FIG. 29 shows an example screen of a user-based feed form that is presented to the user that can be populated by the user, e.g. the title of the feed and the user's name, and saved by clicking the ‘Save’ button on the modal frame. If the user wishes to create a search-based feed, the user taps on the ‘Search’ tab. FIG. 30 shows an example screen of a search-based feed form that is presented to the user that can be populated by the user, e.g. the title of the feed and the search term, and saved. The user can switch between the user-based feed from and the search-based feed form by using the two buttons shown in the middle of the modal form in the examples of FIGS. 29 and 30.

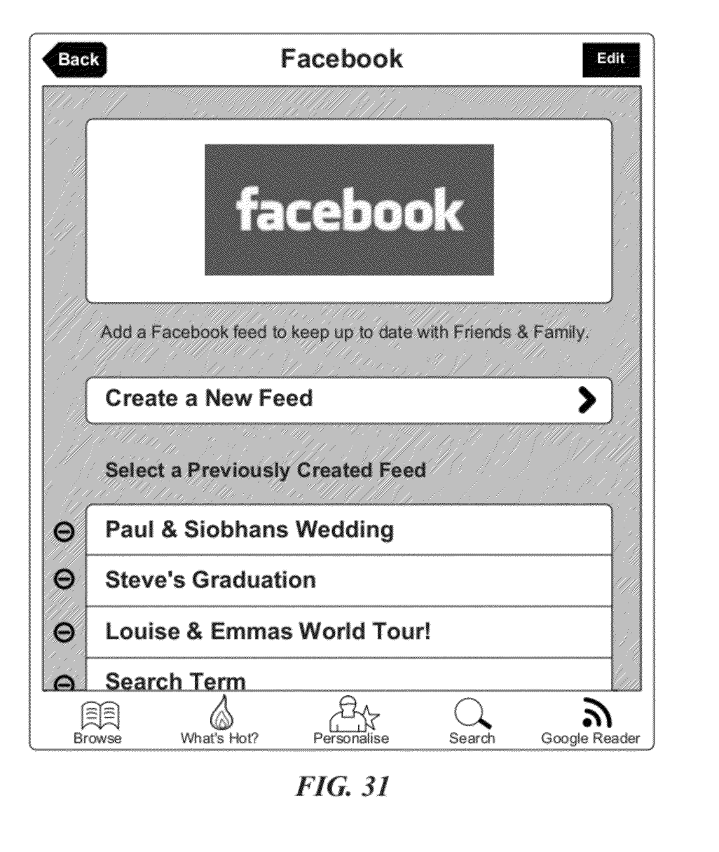

The user can choose to delete existing feeds from a stream. The example screen of FIG. 31 shows an ‘Edit’ button in the upper right corner which the user can select. Then the user is presented with an option to delete feeds.

In one embodiment, the host server 110 includes the navigation module 192 which attaches links between streams, between frames, or between streams and frames that enable a user to navigate from a stream or a frame to another related stream or frame. Linked frames and/or streams can be identified by third-party content providers, users of the customizable content delivery platform, or the navigation module 192. The navigation module 192 can select the frames and/or streams to be linked based on one or more algorithms. For example, the algorithm can determine which frames and/or streams should be linked based on relevance or on potential interest to the user. Inter-stream and inter-frame navigation can be used to, for example, link from a frame to other streams that also contain the frame, or from a frame to other data sources that also contain the content item that the frame displays, or from a stream to other related streams a user might also be interested in, or frame a frame to other related frames a user might also be interested in.

In one embodiment, navigation among streams and frames can be used to develop narratives or hypertext navigation systems across and between streams and frames. For example, users can follow a sequence of links or choose their own adventure by selecting from among various alternative navigation paths.

In one embodiment, the host server 110 includes the GPS engine 180 that communicates with the client device to receive GPS data for the client device. Based on the GPS data, the GPS engine 180 can search for and generate a location-based stream of frames. Types of frames incorporated into this stream include content relevant to the user's current geographical location, the time of day, and other location conditions, for example, weather information, traffic information, events taking place in or near the client device's location, and commerce offers relevant to the location. Non-limiting examples of frame content include local news feeds, advertisements, offers, messages such as Facebook and Twitter or other social media postings that mention the location, and videos or photos tagged with the location's coordinates or name.

In one embodiment, the host server 110 includes the voting module 182 that receives users' votes on the frames contained in a stream and based on the votes selecting the highest rated frames for continued inclusion in a stream. Users can vote for or against any particular frame in a stream by using a pre-determined gesture understood by the gesture module 178 or by selecting a button or menu selection for indicating the user's level of approval or disapproval. Examples of pre-determined gestures that can be used include an upwards or downwards swipe gesture in the context of voting, or a sequential up-down-up gesture that indicates yes, or a sequential left-right-left gesture that indicates no. The gesture module 178 interprets the gesture, and passes the information to the voting module 182. The vote is attached to the frame in the streams database 114. If the vote for a particular stream is too low in comparison to votes for other frames, either in the same stream or in any stream, the frame is deleted from the stream. Voting can apply to any stream, including public streams or shared private streams.

In one embodiment, the voting module 182 receives users' indicated emotional reaction to frame content. The voting module 182 can provide a range of emotional icons ranging from a happy face to a frowning face, and the user taps the location in the range that corresponds to the user's reaction. The voting module 182 collects the emotional reaction data and stores the data in the streams database 114. Any other method of rating the reaction of a user to a frame's content can be used, for example, assigning a number of stars between 1 and 5.

In one embodiment, the host server 110 includes the output module 188 that renders streams and frames for different devices types of mobile devices, such as mobile phones, tablets, and laptops, and stationary devices, such as desktop computers, televisions, digital displays, billboards, and consumer electronics products. The streams and frames rendered by the output module 188 is provided to the user interface engine 170 in the MNA 199 for presentation on the client device to the user.

In one embodiment, the host server 110 includes the television module 190 that interacts with Internet-connected televisions. A user selects the MNA 199 via an on-screen menu, a button on the television, a button on the television's remote control, a touch screen on the television, or another controller such as a smart phone, tablet, or computer that controls the television. Alternatively, the MNA 199 can be presented as a screen saver when the television is idle, for example, after the television has been idle for a pre-set number of minutes, when the user enters screensaver mode via an on-screen menu, a button on the television, a button on the television's remote control, a touch screen on the television, or another controller such as a smart phone, tablet, or computer that controls the television. The television module 190 receives the user's selections and responds accordingly.

In one embodiment, the television module 190 can receive touch screen data and interpret the data as corresponding to pre-defined commands. For example, if the television has a touch screen or if a device that has a touch screen controls the television, the television module 190 can communicate with the television or the device, respectively, to obtain the touch screen data.

In one embodiment, the television module 190 can receive commands via menu controls from the television or from a separate remote control or other device controlling the television.

In one embodiment, the television module 190 can receive commands via a Web interface. The user logs into his account on the host server 110, sets up custom streams on the Web, and then displays the streams using a television connected to the Web. Alternatively, the user can create specific sets of streams for display on different televisions by logging into his account on the host server 110 from a television, for example, via a plug-in or bundled application in the television, and then selecting the set of streams that are to be shown on that television, the default view that should be shown (e.g., newsreader view or slideshow), and any other customization details for viewing the desired streams.

Publishers of content can offer a branded MNA for distributing the publisher's own content through a branded newsreader. In one embodiment, the host server 110 includes the licensing engine 184 that manages a login procedure for authorized licensees using a pre-authorized username and password or other unique identifier. Once a licensee has logged in, the licensing engine 184 allows the licensee to manage pre-tuned streams, the directory of feeds available to users, and featured content sites that the licensee wishes to provide to users of the branded newsreader. The information managed by the licensee is stored in the branding database 116 for access by a branded MNA to be distributed to be offered by the licensee to vendors and distributors.

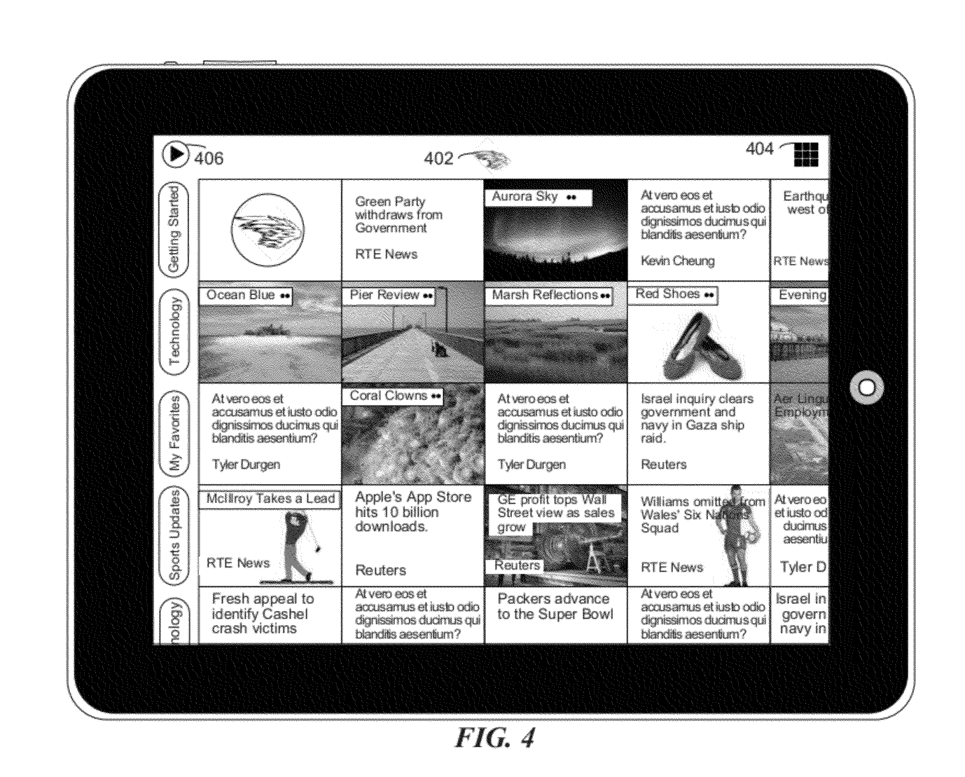

In one embodiment, the licensee provides to the licensing engine 184 key elements of identity such as logo, name, backgrounds, colors, and other digital assets associated with branding a newsreader as a white label product. The licensing engine 184 includes the information in an encoded XML file that is stored in the branding database 116 and is accessed by the MNA 199, resulting in the identity elements in the file being displayed on the newsreader on a client device. For example, the licensee's logo 402 and/or name can be displayed at the top of the branded newsreader on the client device, as shown in the example of FIG. 4.

In one embodiment, the host server 110 includes the randomization module 193 that generates a new stream of frames in response to shaking of the client device 134 by the user as monitored by a gesture module 178 in the MNA 199 on the client device 134. The frames selected for inclusion in the new stream and the order in which the selected frames are placed are algorithmically determined by the randomization module 193. Non-limiting examples of selection algorithms include randomizing all frames in the user's stream-space, selecting frames that have not been marked as read and randomizing their order, selecting frames that are important to the user according to user-selected criteria and randomizing their order, or selecting frames that are relevant to the user according to user-selected criteria and randomizing their order.

FIG. 1C depicts a block diagram illustrating an example of components in the MNA 199 running on a client device that communicates with the user interface of the client device, the host server 110, and the databases 112, 114, 116. The MNA 199 can include, for example, an application network interface 198 and/or a user interface engine 170.

Similar to the network interface 195 in the host server 110, the application network interface 198 can be a networking module that enables the MNA 199 to mediate data in a network with an entity that is external to the MNA 199, through any known and/or convenient communications protocol supported by the host and the external entity.

In one embodiment, the MNA 199 on the client device 134 includes a user interface engine 170 which communicates with the user interface of the user's client device to present frames and streams on the user's client device and receive input from the user, for example through a touch screen of the client device, to manipulate the presentation of the frames and streams on the client device's screen.

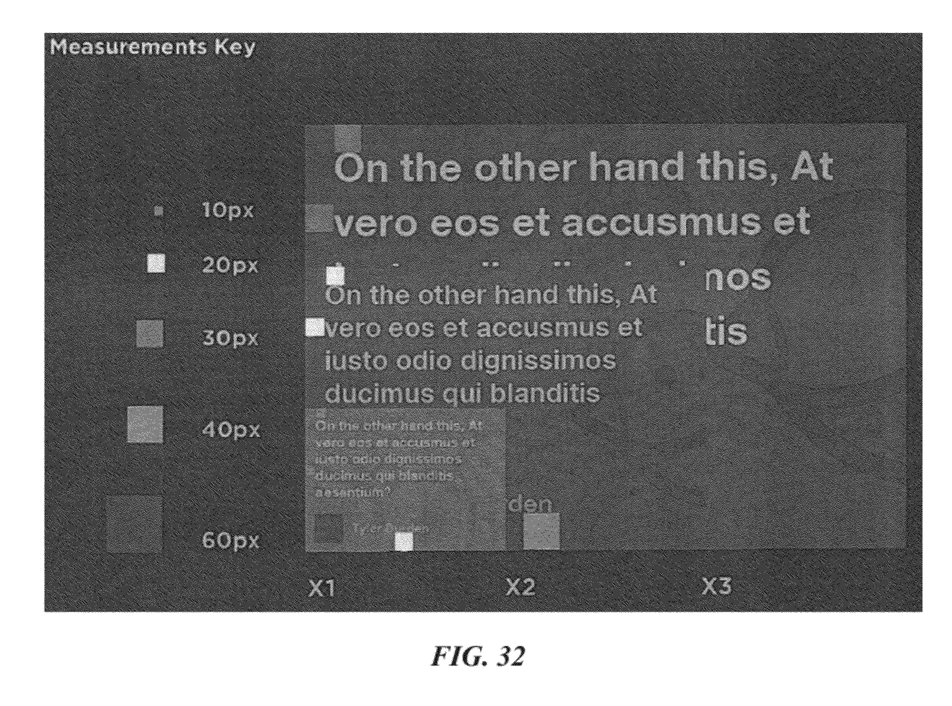

The user interface engine 170 determines and applies the presentation details for the frames and streams, such as the font type and font size. FIG. 32 shows an example measurements key that compares a standard size frame card at 1× to a double height frame card at 2× and a triple height frame card at 3×. A 10 pixel by 10 pixel square is shown for comparison relative to a 20 pixel×20 pixel square, a 30 pixel×30 pixel square, a 40 pixel×40 pixel square, and a 60 pixel×60 pixel square.

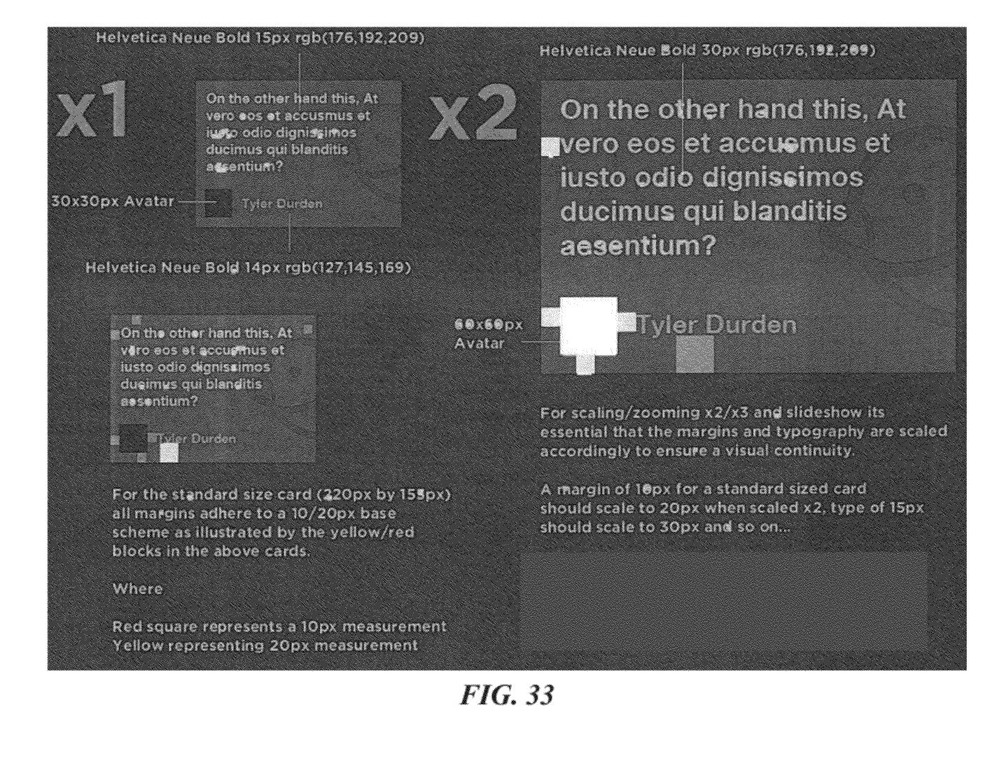

FIG. 33 shows an example of the font type and font size used in a standard size frame card and a double height frame card. In one embodiment, a standard size card is 220 pixels by 155 pixels, and margins of the card adhere to a 10 pixel or 20 pixel base scheme as illustrated in the example of FIG. 33. In one embodiment, the font of the text of a Tweet in the standard size card is Helvetica Neue Bold 15 pixels, and the color using an RGB color model is specified as (176, 192, 209), while the font of the text that states the name of the person sending the Tweet in the standard size card is Helvetica Neue Bold 14 pixels, and the color using an RGB color model is specified as (127,145,169). For zooming a frame to double height and triple height, the margins and typography are scaled accordingly to ensure visual continuity. For example, a margin of 10 pixels for a standard sized card should scale to 20 pixels when scaled to double height. And for a double height frame, the Tweet text font size is 30 pixels with the same font type and color. Additionally, the backgrounds of the card should be similarly scaled.

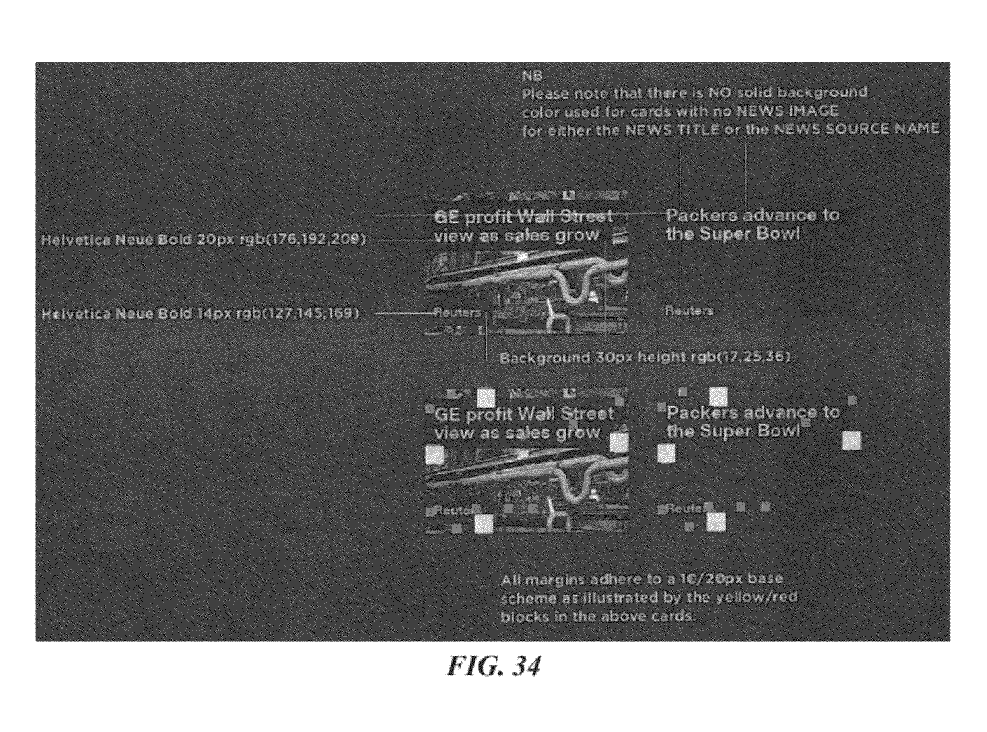

FIG. 34 shows an example of the font type and font size used in a standard size frame card for a news image. In one embodiment, no solid background color is used for cards having no news image for either the news title or the news source name.

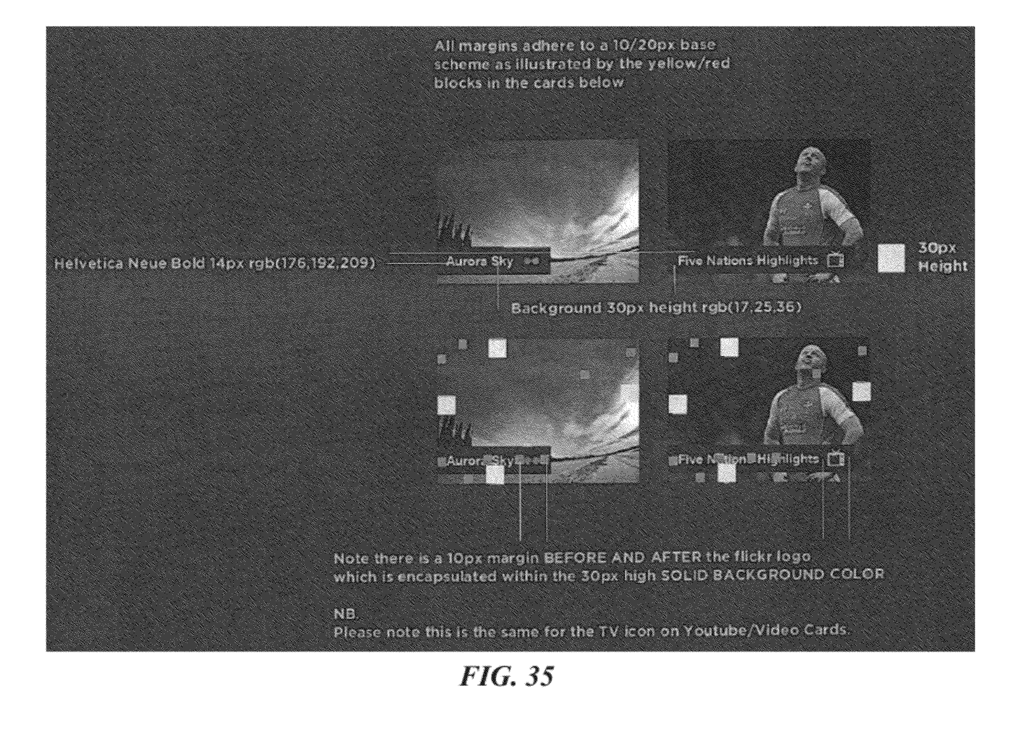

FIG. 35 shows an example of the font type and font size for annotated photographs.

In one embodiment, the user interface engine 170 uses a soft blue/navy color palette for the user interface to allow the user to more easily focus on the content and the typography of the stream view. The user interface engine 170 uses a gentle noise gradient on the background and cards to give a sense of depth, and texture icons are easy to recall and have a chrome finish for easy identification with the design languages of the application's user interface.

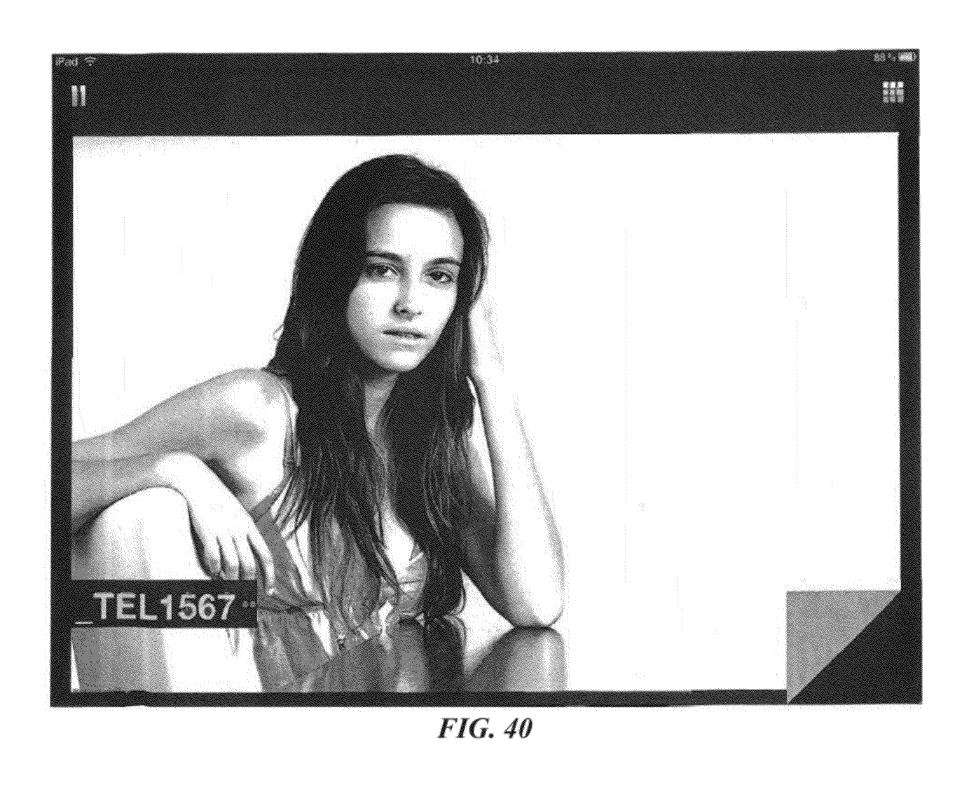

The user interface engine 170 can indicate that the content of a frame has been viewed or read by the user. Non-limiting examples of the indication that can be used include displaying a marker on the frame that can change orientation when read (corresponding to electronically folding a dog-ear on the frame) or using an identifying color, size, border, layout, special icons. or special labels. FIG. 40 shows a dog-eared corner on a full-size screen frame, indicating that the user has marked the frame as having been viewed or read. Once a frame has been marked as read, the user interface engine 170 marks identical frames in the user's stream space with the same indicator.

In one embodiment, the user interface engine 170 can include a gesture module 178, a newsreader module 172, a slideshow module 176, and/or a browser module 179.

In one embodiment, the gesture module 178 communicates with the client device to receive touch screen data provided by the user. The gesture module 178 interprets the data as gestures corresponding to pre-defined commands. For example, if a user taps a frame displayed on a touch screen of a client device, the tapping gesture can be defined as a command to unfold the small frame that is part of a larger stream into a larger presentation view and present further information, such as a summary, more details, or a content browser.

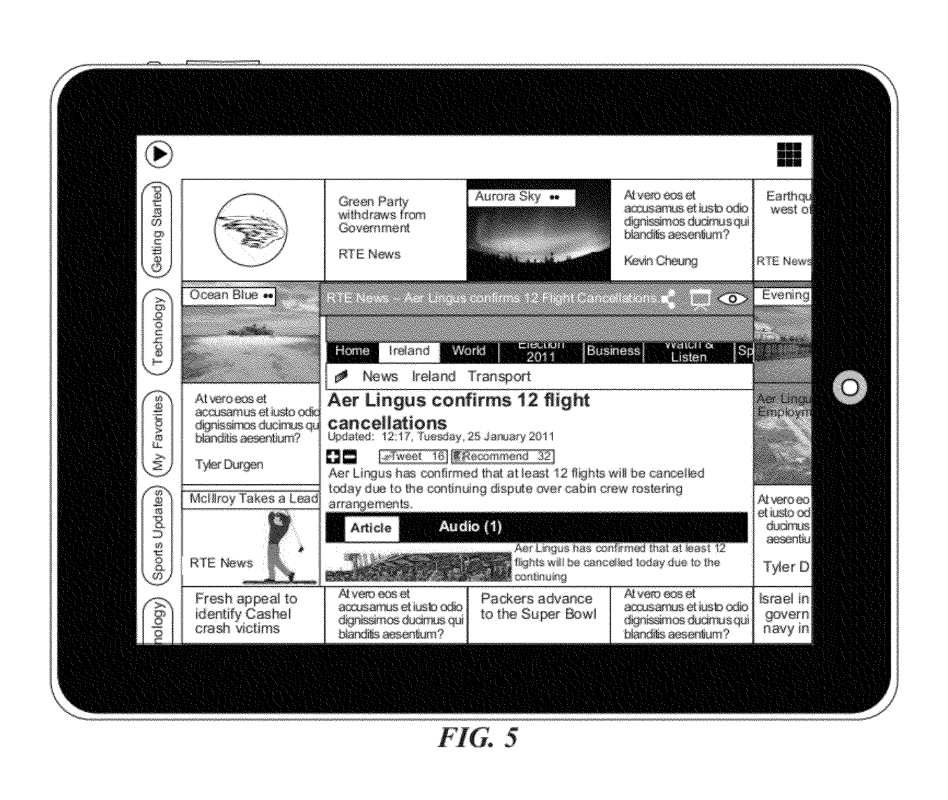

In one embodiment, if the user uses a pinching gesture to virtually pick up a particular frame in a stream, the gesture module 178 can interpret the gesture as a command to unfold the frame into a larger presentation view. There can be several different presentation view sizes with each larger presentation view size selected by successive uses of the frame pinching gesture. For example, a first pinching gesture of a frame can unfold the frame from a standard frame size that is part of a stream to, for example, a double-sized frame whose dimensions are double the standard frame size, and a second pinching gesture on the double-sized frame can unfold the frame to a triple-sized frame whose dimensions are triple the standard frame size. FIG. 5 shows an example frame that has been unfolded to a triple-sized frame.

In one embodiment, if the user uses a pinching gesture to indicate the first and last frames in a range of frames of a stream, essentially a gesture for scooping up part of or all of a stream, the gesture module 178 can interpret the gesture as a command to consolidate the selected frames into a virtual stack. The selected stack of frames can be moved by the user to other streams, shared with other users, deleted, copied, or otherwise manipulated. Alternatively or additionally, there can be other ways to select frames to be stacked, such as clicking on a menu option or entering a command.

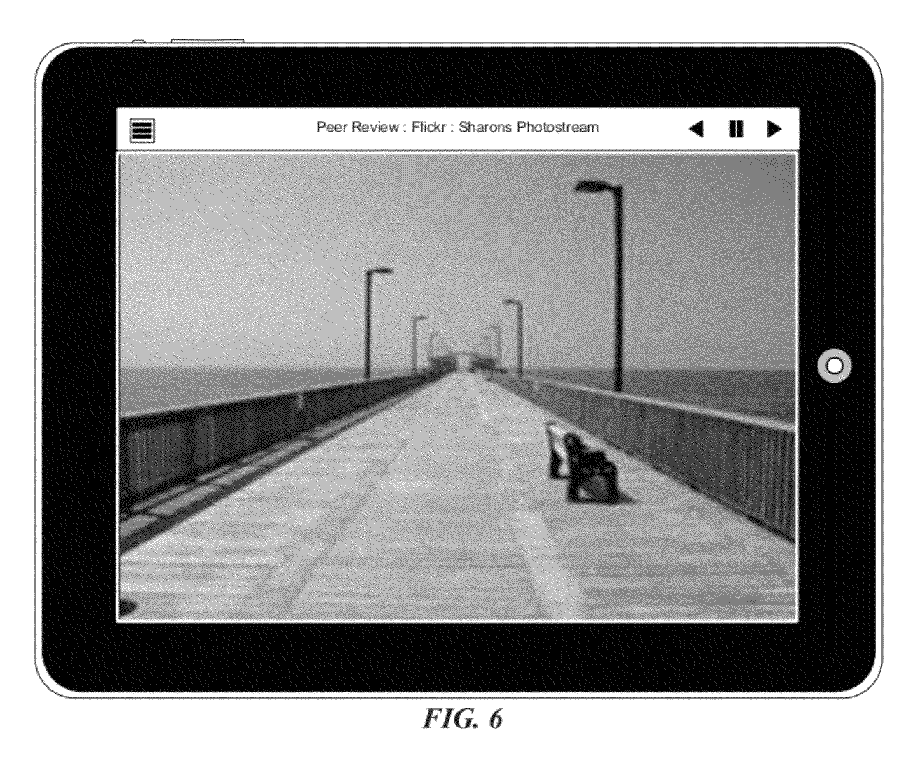

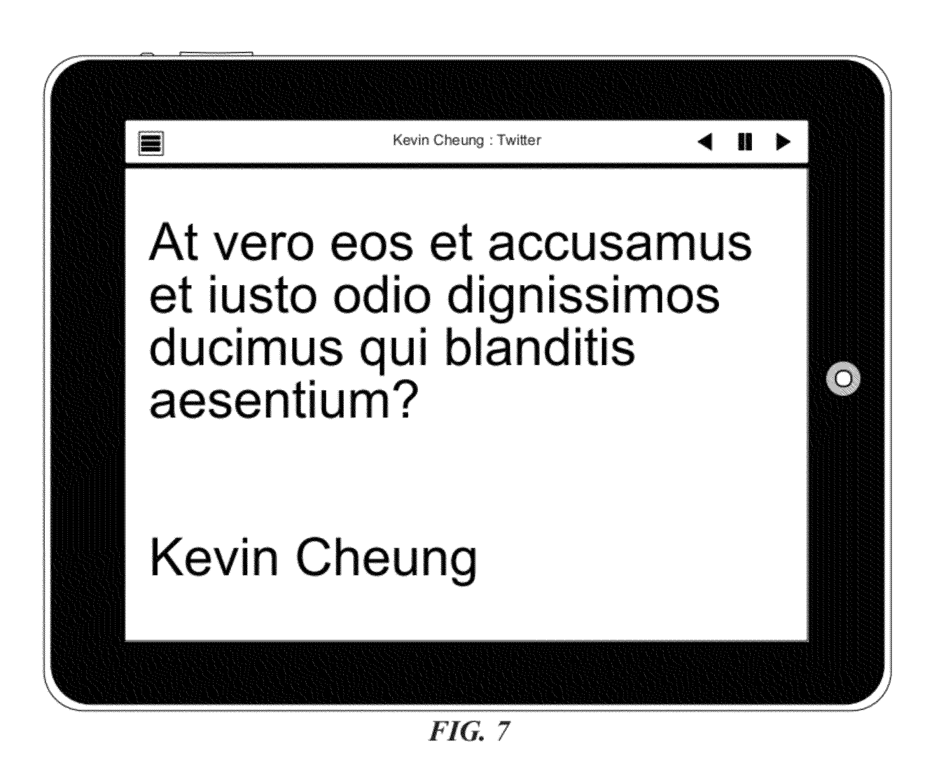

In one embodiment, the slideshow module 176 displays a slideshow of the frames in a selected stream. In slideshow mode, the frames of a stream are shown at full screen size, and the slideshow cycles sequentially through the frames of the stream. An example of a photo in a stream in slideshow mode is shown in FIG. 6. The upper right corner provides controls for the user to go backwards in the slideshow, pause the slideshow, or move forwards in the slideshow. FIG. 7 shows an example of a slideshow mode for a Tweet that also includes controls for selecting the previous Tweet, pausing the slideshow, or selecting the next Tweet.

The slideshow module 176 displays the slideshow mode when the gesture module 178 communicates that it has detected a slideshow gesture made by the user on the touch screen of the client device. In one embodiment, the slideshow gesture can be a swipe gesture moving from left to right or right to left. Further, the user can select the first frame to be displayed in the slideshow by using an ‘unpinch’ gesture with respect to the desired frame. The ‘unpinch’ gesture triggers the slideshow module 176 to expand the frame until it fills the screen of the client device and enters the slideshow mode. Alternatively or additionally, the slideshow mode can be selected using a different operation, such as a selecting a button, command, or menu option. The user can exit the slideshow mode by using a ‘pinch’ gesture on the currently displayed slide on the touch screen, or using some other method of selecting the exit slideshow option, to shrink the slide until it re-enters the stream it is resident in.

In one embodiment, if the user makes a swiping gesture in an upwards or downwards direction while in slideshow mode, the gesture module 178 can interpret the gesture as a command to change the selection of streams being displayed. An upward swipe corresponds to switching to the adjacent stream above the current stream being displayed, and a downward swipe corresponds to switching to the adjacent stream below the current stream being displayed. Alternatively or additionally, switching streams in slideshow mode can be initiated by using, for example, key commands such as the arrow keys, icons such as arrows, selecting the option from a menu, or entering commands.

In one embodiment, if the user selects a frame and uses a drag and drop gesture between streams, the gesture module 178 can interpret the gesture as a command to add the selected frame to a designated stream.

In one embodiment, the gesture module 178 communicates with the client device to receive accelerometer data for the client device. When the gesture module 178 receives accelerometer data corresponding to a shaking gesture, the gesture module 178 sends the information to the randomization module 193 in the host server 110. The randomization module 193 generates a new stream that includes select frames from the user's existing stream space, and then sends the information for the stream to the newsreader module 172 for presenting to the client device 134.

In one embodiment, the newsreader module 172 displays the streams of frames scrolling like a news ticker across the screen. The scrolling speed can be adjusted by the user. FIG. 4 shows an example screen shot provided by the MNA 199 in newsreader mode. The newsreader mode allows a user to monitor content from multiple sources, such as images, news items, videos, social media updates, in a visually appealing format. As shown in the example of FIG. 4, the newsreader module 172 provides a button on the upper left corner that toggles between play and pause functions. The pause button is shown when the newsreader module 172 scrolls the streams across the screen, and the play button is shown when the newsreader module 172 freezes the streams on the screen. The button on the upper right corner can be selected by a user to add more sources or feeds to the user's stream space. The title of each of the user's streams is shown in newsreader mode to the left of the respective streams.

If the user sees something in a frame that he wants to know more about, the user taps on the frame, and the newsreader module 172 opens the frame in preview mode which partially overlays the newsreader in the background, as shown in the example of FIG. 5. The enlarged frame in FIG. 5 has three buttons on the upper right corner. Selecting the leftmost icon allows a user to share the frame using the sharing module 166 in the content mixing engine 160, selecting the middle icon puts the frame and corresponding stream in slideshow mode provided by the slideshow module 176, and selecting the rightmost icon launches a full-screen browser that shows the original source page for the frame as provided by a browser module 179 in the user interface engine 170.

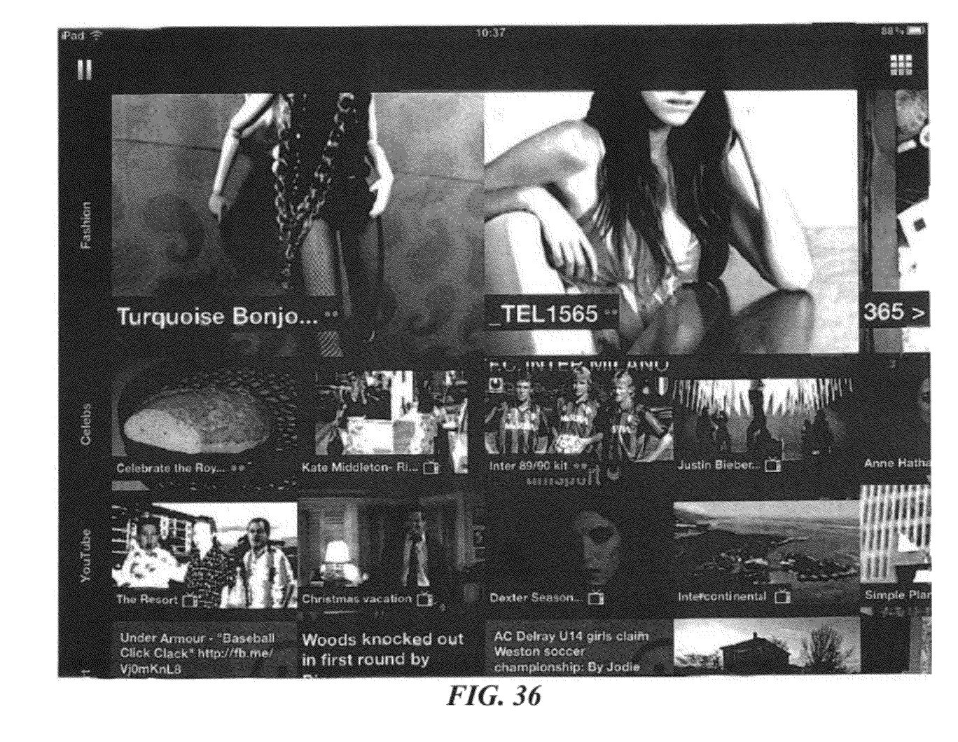

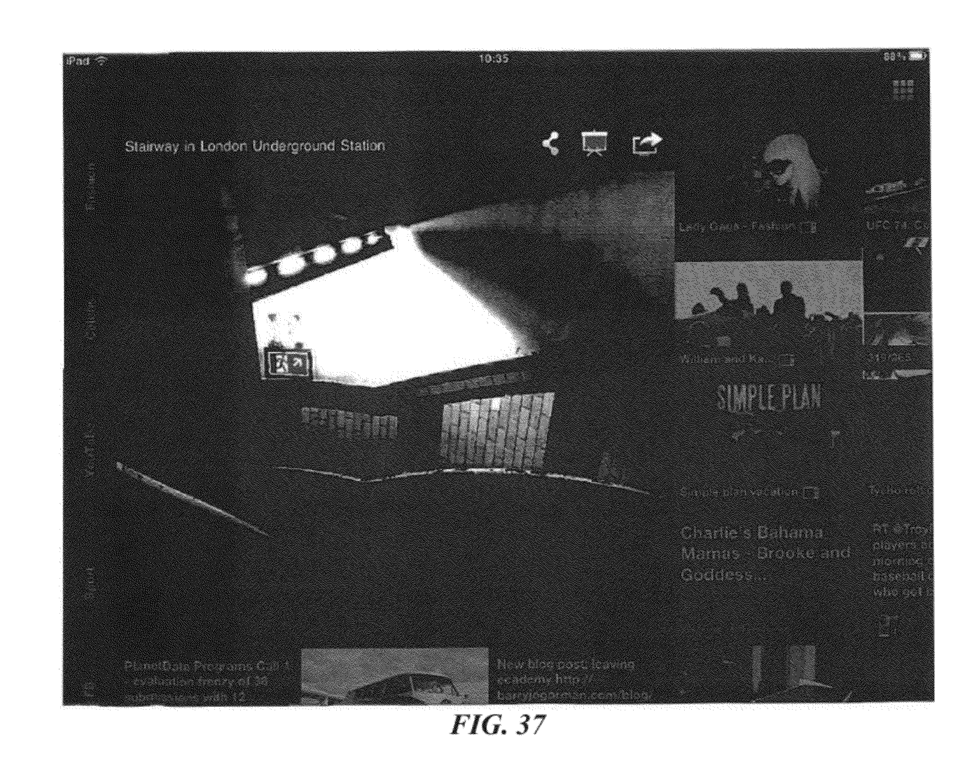

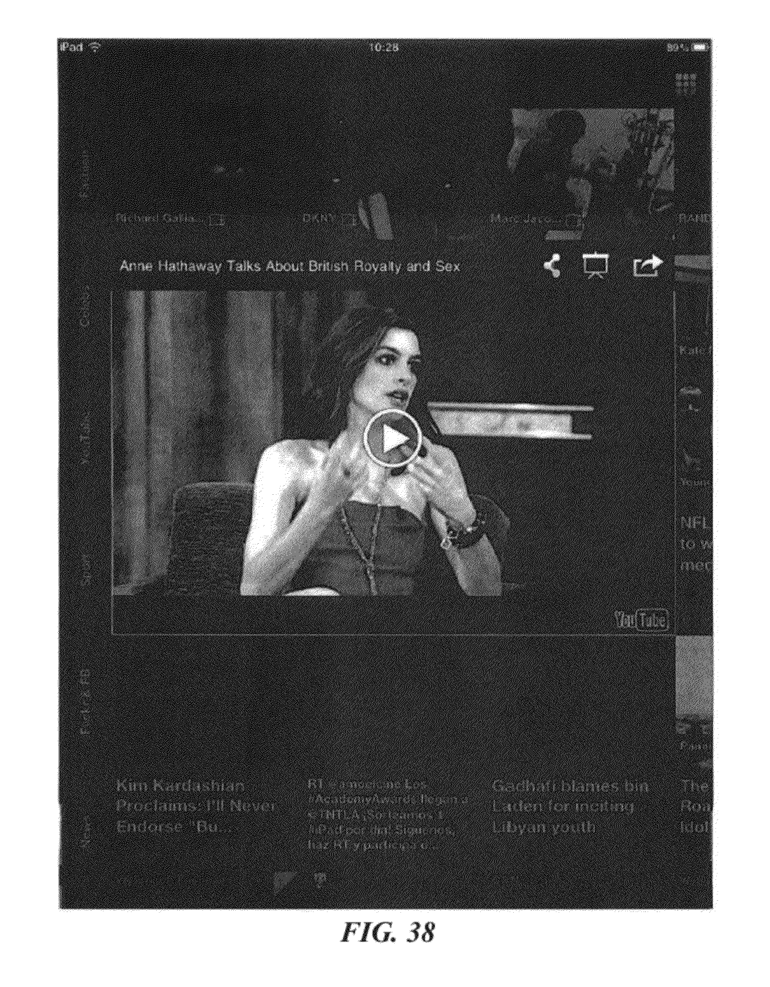

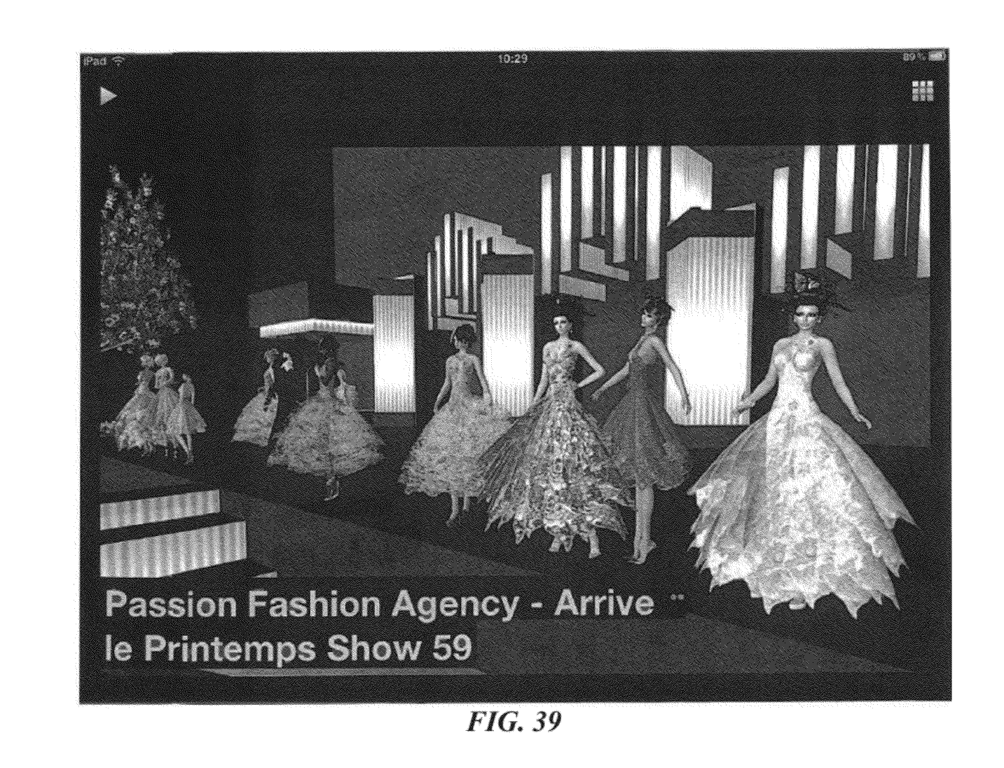

If the user wishes to zoom an entire stream, the user can use the ‘unpinch’ gesture on the stream, and the user interface engine 170 will zoom in on the stream. The stream can be zoomed in repeatedly to double height (shown for example in FIG. 36 in landscape mode and FIG. 38 in portrait mode), triple height (shown for example in FIG. 37), and ultimately to full screen mode (shown for example in FIG. 39).

In one embodiment, the user interface engine 170 includes the browser module 179 that brings up a browser window on the client device 134. The browser window is directed toward a source page for a frame specified by the user.

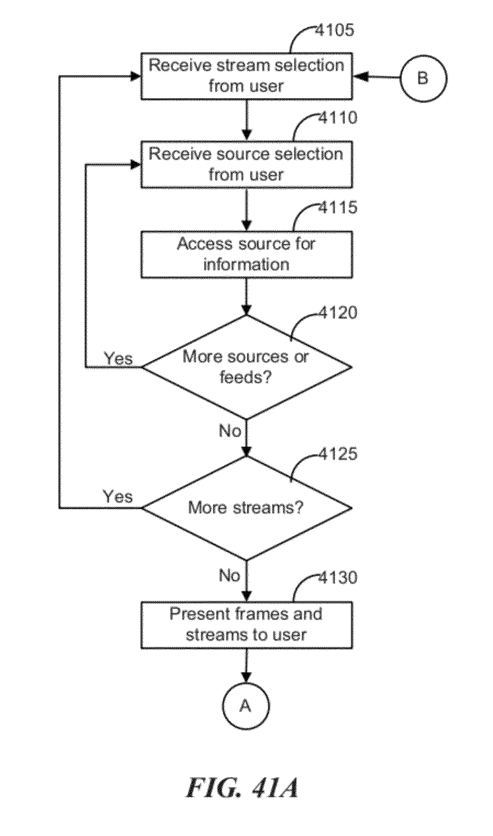

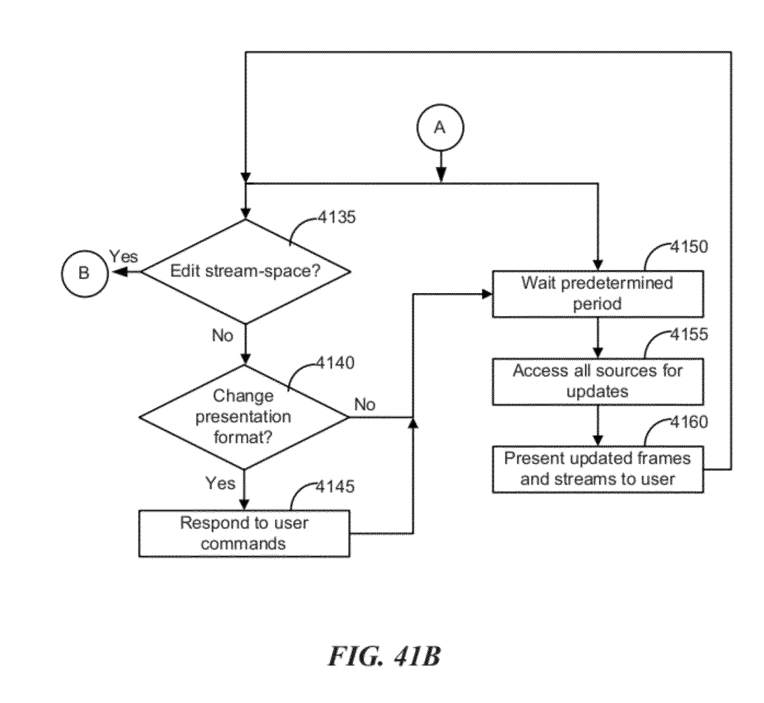

FIGS. 41A and 41B are a flow diagram illustrating an example process of editing a user's stream space. At block 4105, the system receives a stream selection from the user. The stream selection is one of the current streams in the user's stream-space or an indication that the user wishes to add a new stream.

Then at block 4110, the system receives a source or feed selection from the user for adding to the selected stream. The source or feed selection can be specified by the user, or the user can perform a search for a source or feed using the edit mode provided by the editing module 169. At block 4115, the system accesses the source for information to present to the user.

At decision block 4120, the system determines if there are more sources or feeds that the user wishes to include in the selected stream. If there are more sources or feeds (block 4120—Yes), the process returns to block 4110 to receive the next source or feed selection. If there are no more sources to be included in the stream (block 4120—No), at decision block 4125, the system determines if there are more streams to be edited or new streams to be added. If there are more streams to be edited or added (block 4125—Yes), the process returns to block 4105 to receive the next stream selection.

If there are no more streams to be edited or added (block 4125—No), at block 4130 the system presents the new frames and new and/or edited streams to the user along with previous frames and streams selected by the user.

Then at block 4150, the system waits a predetermined period of time before accessing all sources and feeds in the user's stream-space for updates at block 4155. The predetermined time period begins when the system last accessed the sources for updates. For example, the system may check for updates every hour. The system presents the updated frames and streams to the user at block 4160 and goes to decision block 4135 to determine if the user wishes to edit the stream-space.

While waiting during the predetermined period of time before accessing the sources for updates, at decision block 4135 the system determines if the user wishes to edit the stream-space again. If the user wishes to edit the stream-space (block 4135—Yes), the process returns to block 4105 to receive the stream selection.

If the user does not wish to edit the stream-space (block 4135—No), at decision block 4140, the system determines if the user wishes to change the presentation format of the stream-space. If the user does not indicate any changes to the presentation format (block 4140—No), the process continues to block 4150 where the system waits the rest of the predetermined waiting period.

If the user wants to change the presentation format (block 4140—Yes), at block 4145 the system responds to the user commands. The user commands can be made with gestures on a touch screen or through any other method, for example, selecting a button, command, or menu option using a keyboard or other input device. Commands can include, but are not limited to, zooming in on a frame or stream; changing to slideshow mode, newsreader mode, or any other presentation mode; and reordering frames or streams. Then the process continues to block 4150 where the system waits the rest of the predetermined waiting period.

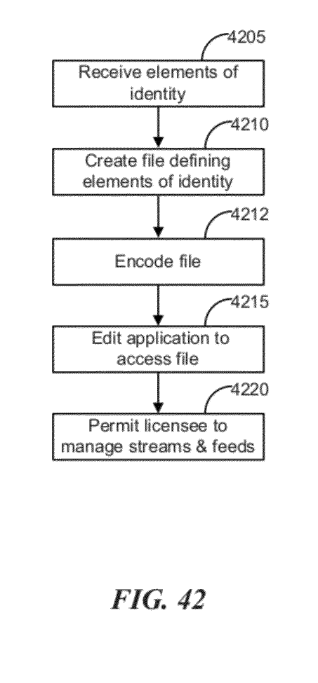

FIG. 42 is a flow diagram illustrating an example process of creating a branded newsreader application. Publishers can offer the branded newsreader for content that they provide.

At block 4205, the system receives elements of identity from a publisher or other entity desiring to license the MNA as a branded newsreader. Non-limiting examples of elements of identity include as logo, name, backgrounds, and color scheme. Then at block 4210, the system creates a file, such as an XML file that defines the provided elements of identity. And at block 4212, the system encodes the file so that branding can only be changed by authorized personnel.

At block 4215, the MNA is edited to access the encoded file so that newsreader presented to a user who uses the MNA sees the brand and name of the licensee when using the newsreader.

At block 4220, the system permits the licensee to login to the host server 110 to manage pre-tuned streams, the directory of feeds available to users of the branded MNA, and featured content sites.

At this point, the branded application is ready for distribution by the licensee.

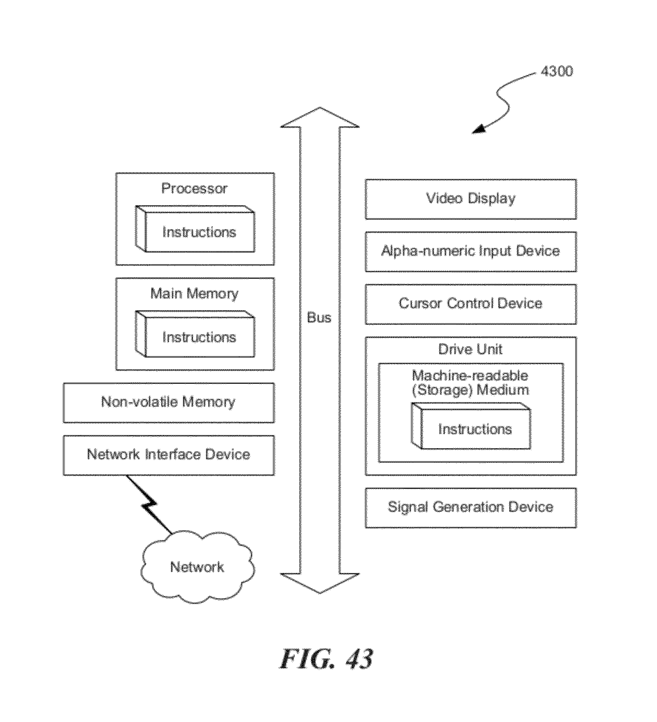

FIG. 43 shows a diagrammatic representation of a machine 4300 in the example form of a computer system within which a set of instructions, for causing the machine to perform any one or more of the methodologies discussed herein, may be executed

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 4300 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. For example, some of the components described in the user interface engine 170 can be in the host server 110, and some of the components described in the host server 10 can be in the user interface engine 170. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

1. A computer implemented method of providing a newsreader on an electronic device, the method comprising:
receiving a plurality of heterogeneous information packets;
packaging the plurality of information packets into a plurality of electronic content containers, wherein the plurality of electronic content containers are standardized for different types of information packets;
presenting the plurality of electronic content containers on a screen of the device to a user;
checking for updates to the plurality of information packets and updating the corresponding electronic content containers.

2. The method of claim 1, wherein the plurality of information packets come from multiple sources.

3. The method of claim 1, further comprising making a selected electronic content container identified by the user available to other users.

4. The method of claim 3, wherein making the selected electronic content container available to other users comprises making a link to a source of the information packet in the selected the electronic content container and a framing structure for the selected electronic content container available to other users.

5. The method of claim 1, further comprising organizing the plurality of electronic content containers into one or more presentation structures, wherein the organizing is based on user input, and further wherein presenting the plurality of electronic content containers comprises presenting the one or more presentation structures in which the plurality of content containers resides.

6. The method of claim 5, further comprising selecting one or more sources for providing the plurality of information packets.

7. The method of claim 5, further comprising receiving a selection of one or more sources specified by a third party for providing the plurality of information packets.

8. The method of claim 5, further comprising receiving a selection of one or more sources specified by the user for providing the plurality of information packets.

9. The method of claim 5, further comprising making a selected presentation structure identified by the user available to other users.

10. The method of claim 9, wherein making the selected presentation structure available to other users comprises making a link to a source for each of the information packets in the electronic content containers that comprise the selected presentation structure and a framing structure for each of the electronic content containers that comprise the selected presentation structure available to other users.

11. The method of claim 5, wherein presenting the one or more presentation structures comprises cyclically scrolling the one or more presentation structures across the screen.

12. The method of claim 5, wherein presenting the one or more presentation structures comprises showing each of the plurality of electronic content containers comprising a selected presentation structure as a full screen slideshow.

13. The method of claim 1, further comprising:
displaying a marker on each of the electronic content containers;
changing an orientation of the marker when the electronic content container has been identified as read by the user.

14. The method of claim 13, further comprising changing the orientation of the marker for each incidence of a particular electronic content container that appears in more than one presentation structure.

15. The method of claim 5, wherein the screen is a touch screen, and the user controls the newsreader through a plurality of gestures on the touch screen.

16. The method of claim 15, wherein a first gesture of the plurality of gestures is a tap on one of the electronic content containers on the screen, and further wherein the first gesture corresponds to a command to present more information from the electronic content container than shown on the screen.

17. The method of claim 15, wherein a second gesture of the plurality of gestures is an unpinching gesture over one of the electronic content containers on the screen, and further wherein the second gesture corresponds to a command to present the electronic content container in a larger view.

18. The method of claim 15, wherein a third gesture of the plurality of gestures is a pinching gesture over a series of electronic content containers in a presentation structure on the screen, and further wherein the third gesture corresponds to a command to group the series of electronic content containers for manipulation.

19. The method of claim 18, wherein manipulation includes one of: sharing, deleting, or copying the series of electronic content containers, or moving the series of electronic content containers to another presentation structure.

20. The method of claim 15, wherein a fourth gesture of the plurality of gestures is a vertical swiping gesture while in slideshow mode on one of the electronic content containers on the screen, and further wherein the fourth gesture corresponds to switching to a different presentation structure in a direction of the vertical swiping gesture.

21. The method of claim 15, wherein a fifth gesture of the plurality of gestures is a dragging and dropping gesture of one of the electronic content containers on the screen, and further wherein the fifth gesture corresponds to moving the one of the electronic content containers from a first presentation structure to a second presentation structure.

22. The method of claim 21, wherein the second presentation structure is stored and accessible by any authorized user.

23. The method of claim 5, further comprising upon determining shaking of the device, generating a new presentation structure containing one or more of the plurality of electronic content containers in a particular order, wherein an algorithm determines the one or more of the plurality of electronic containers included in the new presentation structure and the particular order.

24. The method of claim 23, wherein the algorithm randomizes the plurality of electronic content containers.

25. The method of claim 23, wherein the algorithm includes at least one of the following in the new presentation structure: electronic content containers that have not been read, electronic content containers that are important to the user based upon user-selected criteria, or electronic content containers that are relevant to the user based upon user-selected criteria.

26. The method of claim 5, further comprising:
receiving a location of the electronic device;
generating a location-based presentation structure, wherein the location-based presentation structure includes a plurality of location-based electronic content containers whose information packets are relevant to the location of the electronic device.

27. The method of claim 26, wherein the information packets are also relevant to a current time and other local conditions.

28. The method of claim 5, further comprising:
receiving ratings from the user regarding one or more of the plurality of electronic content containers in a shared presentation structure, wherein the shared presentation structure is one of the one or more presentation structures, and further wherein other users can view the shared presentation structure;
aggregating ratings from the other users regarding the plurality of electronic content containers in the shared presentation structure;
deleting a particular electronic content container from the shared presentation structure if the rating for the particular electronic content container is lower than other electronic content containers in the shared presentation structure.

29. The method of claim 5, further comprising:
receiving emotional reactions from the user regarding one or more of the plurality of electronic content containers;
suggesting a particular electronic content container to another user having similar emotional reactions to electronic content containers.

30. The method of claim 5, further comprising rendering the presentation of the one or more presentation structures for display on the screen of a plurality of different devices.

31. The method of claim 30, wherein one of the plurality of different devices is a television, and commands pertaining to the presentation of the one or more presentation structures are provided via one of the following inputs: an on-screen menu or key on the electronic device, an on-screen menu or key on a remote control for the television, a touch screen on the television, a controller for the television, or a web interface, wherein the user creates a set of television presentation structures for display on different televisions.

32. The method of claim 30, wherein one of the plurality of different devices is a television, and the presentation of the one or more presentation structures is used as a screensaver for the television.

33. The method of claim 5, further comprising attaching metadata to the plurality of electronic content containers and to the one or more presentation structures.

34. The method of claim 33, wherein the metadata is selected from the following: how to render the information packets, read-write permissions for access to the information packets, provenance of the information packets, links to related information packets, library reference information related to the information packets, product SKU or ordering information, e-commerce affiliate codes, relevant concepts, taxonomy or ontology links, semantic metadata, header information, sentiment data, content usage statistics, application specific metadata, user-account metadata, and customizable data.

35. The method of claim 5, further comprising providing a link between a first electronic content container and a second electronic content container, between a first presentation structure and a second presentation structure, or between a third electronic content container and a third presentation structure.

36. The method of claim 35, wherein the link is added by the user, by a third-party content provider, or determined by an algorithm, wherein the algorithm links related items based on relevance or potential interest to the user.

37. A computer-implemented method comprising:
receiving elements of identity from a licensee;
creating a file defining the elements of identity;
providing an application for distribution that provides a newsreader on an electronic device to the licensee, wherein the application accesses the file to display the elements of identity within the newsreader when displayed to a user,
wherein the newsreader presents a plurality of presentation structures comprising one or more electronic content containers, wherein the electronic content containers are standardized for different types of information packets, and further wherein the information packets are provided by one or more sources.

38. The method of claim 37, wherein at least some of the one or more sources are specified by the licensee.

39. A system for providing a newsreader on an electronic device, the system comprising:
means for packaging a plurality of information packets into a plurality of electronic content containers, wherein the plurality of electronic content containers are standardized for different types of information packets;
means for presenting the plurality of electronic content containers on a screen of the device to a user.

40. The system of claim 39, further comprising means for organizing the plurality of electronic content containers into one or more presentation structures, wherein the organizing is based on user commands, and further wherein means for presenting the plurality of electronic content containers comprises means for presenting the one or more presentation structures in which the plurality of content containers resides.

41. A tablet computer newsreader system, the system comprising:
a display;
at least one memory component storing a software program;
at least one input/output device;
a processor coupled among the display, the memory component, and the input/output device, wherein the processor is configured to execute the software program, the software program comprising:
a first module for packaging a plurality of information packets into a plurality of electronic content containers, wherein the plurality of electronic content containers are standardized for different types of information packets;
a second module for organizing the plurality of electronic content containers into one or more presentation structures, wherein the organizing is based on user commands entered using the input/output device, wherein the input/output device comprises a touch screen;
a third module for presenting the one or more presentation structures on the display to a user.

42. A computer implemented method of providing a newsreader on an electronic device, the method comprising:
causing to be displayed a plurality of electronic content containers in one or more streams across a screen of the electronic device, wherein each of the plurality of electronic content containers corresponds to a standardized information packet, and there are multiple types of information packets;
in response to receiving commands from a user to manipulate a presentation format of the one or more streams, changing the presentation format.

43. The method of claim 42, wherein the presentation format is selected from a newsreader format or a slideshow format.

44. The method of claim 42, wherein the presentation format changes a size of a selected electronic content container relative to other displayed electronic content containers.

45. The method of claim 42, wherein the screen of the electronic device is a touch screen, and the commands are touch screen gestures.
